(19) United States
(12) Patent Application Publication
(10) Pub. No.: US 2008/0206113 A1
(43) Pub. Date: Aug. 28, 2008

(54) Hydrogen Generating Fuel Cell Cartridges

(75) Inventors: Constance R. Stepan, Oxford, CT (US); Paul Adams, Monroe, CT (US); Andrew J. Curello, Hamden, CT (US); Anthony Sgroi, Wallingford, CT (US); Floyd Fairbanks, Naugatuck, CT (US)

Correspondence Address: THE H.T. THAN LAW GROUP, WATERFRONT CENTER SUITE 560, 1010 WISCONSIN AVENUE NW, WASHINGTON, DC, 20007, US

(73) Assignee: Societe BIC, Clichy Cedex (FR)

(21) Appl. No.: 11/917,231

(22) PCT Filed: Jun. 12, 2006
(86) PCT No.: PCT/US06/22842

§ 371 Date: Dec. 12, 2007

Related U.S. Application Data
(60) Provisional application No. 60/689,538, filed on Jun. 13, 2005.

(51) Int. Cl. B01J 19/00; H01M 8/06

(52) U.S. Cl. 422/129; 429/19

(57) ABSTRACT

A gas-generating apparatus (12) includes a fuel introducing system that has a fuel transporting system that is pressure regulated and indexed. A reaction chamber (18) having a fluid fuel component (22) and an indexing mechanism (24) operatively connected to a solid fuel component are provided. The solid fuel component of the present invention is introduced into the fluid fuel component within the reaction chamber. Further, the indexing mechanism includes a ratcheting mechanism that may be in direct contact with the fluid fuel component. Alternatively, the reaction chamber may be contained within a pod which also contains the reservoir containing the fluid fuel component, a plurality of which are provided. The indexing mechanism advances the pods sequentially so that the fuel components may be introduced. Other indexing mechanisms are provided. A secondary fuel cell (14′) may be provided to extract excess production from the reaction chamber.

### BACKGROUND OF THE INVENTION

Fuel cells are devices that directly convert chemical energy of reactants, i.e., fuel and oxidant, into direct current (DC) electricity. For an increasing number of applications, fuel cells are more efficient than conventional power generation, such as combustion of fossil fuel, as well as portable power storage, such as lithium-ion batteries.

In general, fuel cell technology includes a variety of different fuel cells, such as alkali fuel cells, polymer electrolyte fuel cells, phosphoric acid fuel cells, molten carbonate fuel cells, solid oxide fuel cells and enzyme fuel cells. Today's more important fuel cells can be divided into several general categories, namely (i) fuel cells utilizing compressed hydrogen (H₂) as fuel; (ii) proton exchange membrane (PEM) fuel cells that use alcohols, e.g., methanol (CH₃OH), metal hydrides, e.g., sodium borohydride (NaBH₄), hydrocarbons, or other fuels reformed into hydrogen fuel; (iii) PEM fuel cells that can consume non-hydrogen fuel directly or direct oxidation fuel cells; and (iv) solid oxide fuel cells (SOFC) that directly convert hydrocarbon fuels to electricity at high temperature.

Compressed hydrogen is generally kept under high pressure and is therefore difficult to handle. Furthermore, large storage tanks are typically required and cannot be made sufficiently small for consumer electronic devices. Conventional reformat fuel cells require reformers and other vaporization and auxiliary systems to convert fuels to hydrogen to react with oxidant in the fuel cell. Recent advances make reformer or reformat fuel cells promising for consumer electronic devices. The most common direct oxidation fuel cells are direct methanol fuel cells or DMFC. Other direct oxidation fuel cells include direct ethanol fuel cells and direct tetramethyl orthocarbonate fuel cells. DMFC, where methanol is reacted directly with oxidant in the fuel cell, is the simplest and potentially smallest fuel cell and also has promising power application for consumer electronic devices. SOFC convert hydrocarbon fuels, such as butane, at high heat to produce electricity. SOFC requires relatively high temperature in the range of 1000° C. for the fuel cell reaction to occur.

The chemical reactions that produce electricity are different for each type of fuel cell. For DMFC, the chemical-electrical reaction at each electrode and the overall reaction for a direct methanol fuel cell are described as follows:

Half-reaction at the anode:

CH₃OH+H₂O→CO₂+6H⁺+6e⁻

Half-reaction at the cathode:

1.5O₂+6H⁺+6e⁻→3H₂O

The overall fuel cell reaction:

CH₃OH+1.5O₂→CO₂+2H₂O

Due to the migration of the hydrogen ions (H⁺) through the PEM from the anode to the cathode and due to the inability of the free electrons (e⁻) to pass through the PEM, the electrons flow through an external circuit, thereby producing an electrical current through the external circuit. The external circuit may be used to power many useful consumer electronic devices, such as mobile or cell phones, calculators, personal digital assistants, laptop computers, and power tools, among others.

DMFC is discussed in U.S. Pat. Nos. 5,992,008 and 5,945,231, which are incorporated herein by reference in their entireties. Generally, the PEM is made from a polymer, such as Nafion® available from DuPont, which is a perfluorinated sulfonic acid polymer having a thickness in the range of about 0.05 mm to about 0.50 mm, or other suitable membranes. The anode is typically made from a Teflonized carbon paper support with a thin layer of catalyst, such as platinum-ruthenium, deposited thereon. The cathode is typically a gas diffusion electrode in which platinum particles are bonded to one side of the membrane.

In a chemical metal hydride fuel cell, sodium borohydride is reformed and reacts as follows:

NaBH₄₊2H₂O→(heat or catalyst)→4(H₂)+(NaBO₂)

Half-reaction at the anode:

H₂→2H⁺+2e⁻

Half-reaction at the cathode:

2(2H⁺+2e⁻)+O₂→2H₂O

Suitable catalysts for this reaction include platinum and ruthenium, and other metals. The hydrogen fuel produced from reforming sodium borohydride is reacted in the fuel cell with an oxidant, such as O₂, to create electricity (or a flow of electrons) and water byproduct. Sodium borate (NaBO₂) byproduct is also produced by the reforming process. A sodium borohydride fuel cell is discussed in U.S. Pat. No. 4,261,956, which is incorporated herein by reference in its entirety.

One of the most important features for fuel cell application is fuel storage. Another important feature is to regulate the transport of fuel out of the fuel cartridge to the fuel cell. To be commercially useful, fuel cells such as DMFC or PEM systems should have the capability of storing sufficient fuel to satisfy the consumers' normal usage. For example, for mobile or cell phones, for notebook computers, and for personal digital assistants (PDAs), fuel cells need to power these devices for at least as long as the current batteries and, preferably, much longer. Additionally, the fuel cells should have easily replaceable or refillable fuel tanks to minimize or obviate the need for lengthy recharges required by today's rechargeable batteries.

One disadvantage of the known hydrogen gas generators is that once the reaction starts the gas generator cartridge cannot control the reaction. Thus, the reaction will continue until the supply of the reactants runs out or the source of the reactant is manually shut down.

Accordingly, there is a desire to obtain a hydrogen gas generator apparatus that is capable of self-regulating the flow of at least one reactant into the reaction chamber.

### SUMMARY OF THE INVENTION

The present invention is directed toward fuel systems/gas-generating apparatus that have significantly longer shelf life and are more efficient in producing hydrogen.

In one embodiment, the present invention relates to a gas-generating apparatus that includes at least a reaction chamber having a first reactant, and an inducing mechanism operatively connected to a second reactant to release a predetermined amount of the second reactant to react with the first reactant within the reaction chamber. Preferably, the first reactant is a liquid and the second reactant is a solid.

In another embodiment, the gas-generating apparatus of the present invention includes a reaction chamber having a reactant, a take-up wheel, and a feeding wheel. The take-up wheel of the present invention is, preferably, an indexing wheel.

According to one example of the present invention, the gas-generating apparatus includes a reaction chamber having an indexing wheel that is at least partially teethed or knurled, and a fuel stick urged in contact with the knurled indexing wheel to free a portion of the fuel stick. Alternatively, the indexing wheel has a knurled portion and a polymer encased portion.

In another example, the gas-generating apparatus of the present invention includes a fuel introducing system having a fuel transporting system, wherein the fuel transporting system introduces the fuel into the reactant to produce hydrogen.

It is to be understood that both the foregoing general description and the following detailed description are exemplary and explanatory only and are intended to provide a further explanation of the present invention, as claimed.

### BRIEF DESCRIPTION OF THE DRAWINGS

In the accompanying drawings, which form a part of the specification and are to be read in conjunction therewith and in which like reference numerals are used to indicate like parts in the various views:

FIG. 1 is a front cross-sectional schematic view of an embodiment of a fuel supply according to the present invention;

FIG. 1A is a side cross-sectional schematic view of the embodiment in FIG. 1 illustrating the ratcheting mechanism;

FIG. 2 is a schematic side view of an alternate ratcheting mechanism;

FIG. 2A is a schematic side view of another alternate ratcheting mechanism;

FIG. 2B is an exploded view of the ratcheting mechanism of FIG. 2A;

FIG. 2C is an exploded view of the ratcheting mechanism of FIG. 2A;

FIG. 3 is a side cross-sectional schematic view of an alternative embodiment of the ratcheting mechanism;

FIG. 4 is a schematic side view of an alternate embodiment of a fuel supply according to the present invention;

FIG. 4A is an enlarged, cross-sectional schematic view of an alternate fuel pod for use in the fuel supply of FIG. 4;

FIG. 4B is an enlarged, cross-sectional schematic view of another alternate fuel pod for use in the fuel supply of FIG. 4;

FIG. 4C is a schematic view of an alternate actuation mechanism for the fuel pod shown in FIG. 4B;

FIG. 4D is a schematic cross-sectional view of a fuel capsule for use with the fuel pod shown in FIG. 4B;

FIG. 4E is schematic cross-sectional view of an alternate fuel capsule for use with the fuel pod shown in FIG. 4B;

FIG. 5 is a top schematic partial cross-sectional view of an alternative embodiment of the ratcheting mechanism;

FIG. 6 is a top schematic partial cross-sectional view of a fuel supply according to another embodiment of the present invention having take-up wheel;

FIG. 7 is front schematic cross-sectional view of another fuel supply having a fuel stick and a wheel having a plurality of teeth;

FIG. 8 is a front schematic cross-sectional view of another fuel supply having a fuel stick and a wheel, wherein a portion of the wheel includes a plurality of teeth and another portion of the wheel includes a sealing material;

FIG. 9 is a front schematic cross-sectional view of a fuel supply having a fuel transporting system according to another embodiment of the present invention;

FIGS. 10 and 11 are enlarged, partial views of the fuel transporting system of FIG. 9 showing the operation of the feeding mechanism at pressurized and unpressurized states, respectively; and

FIG. 12 is a schematic view of a fuel transfer system for use with any fuel supply according to the present invention.

### DETAILED DESCRIPTION OF THE PREFERRED EMBODIMENTS

As illustrated in the accompanying drawings and discussed in detail below, the present invention is directed to a fuel supply, which stores fuel cell fuels, such as methanol and water, methanol/water mixture, methanol/water mixtures of varying concentrations, pure methanol, and/or methyl clathrates described in U.S. Pat. Nos. 5,364,977 and 6,512,005 B2, which are incorporated herein by reference in their entirety. Methanol and other alcohols are usable in many types of fuel cells, e.g., DMFC, enzyme fuel cells and reformat fuel cells, among others. The fuel supply may contain other types of fuel cell fuels, such as ethanol or alcohols, metal hydrides, such as sodium borohydrides, other chemicals that can be reformatted into hydrogen, or other chemicals that may improve the performance or efficiency of fuel cells. Fuels also include potassium hydroxide (KOH) electrolyte, which is usable with metal fuel cells or alkali fuel cells, and can be stored in fuel supplies. For metal fuel cells, fuel is in the form of fluid borne zinc particles immersed in a KOH electrolytic reaction solution, and the anodes within the cell cavities are particulate anodes formed of the zinc particles. KOH electrolytic solution is disclosed in United States published patent application no. 2003/0077493, entitled “Method of Using Fuel Cell System Configured to Provide Power to One or More Loads,” published on Apr. 24, 2003, which is incorporated herein by reference in its entirety. Fuels can also include a mixture of methanol, hydrogen peroxide and sulfuric acid, which flows past a catalyst formed on silicon chips to create a fuel cell reaction. Moreover, fuels include a blend or mixture of methanol, sodium borohydride, an electrolyte, and other compounds, such as those described in U.S. Pat. Nos. 6,554,877, 6,562,497, and 6,758,871, which are incorporated herein by reference in their entireties. Furthermore, fuels include those compositions that are partially dissolved in a solvent and partially suspended in a solvent, as described in U.S. Pat. No. 6,773,470 and those compositions that include both liquid fuel and solid fuels, described in United States published patent application no. 2002/0076602. These references are also incorporated by reference in their entireties.

Fuels can also include a metal hydride such as sodium borohydride (NaBH₄) and water, discussed above. Fuels can further include hydrocarbon fuels, which include, but are not limited to, butane, kerosene, alcohol, and natural gas, as set forth in United States published patent application no. 2003/0096150, entitled “Liquid Hereto-Interface Fuel Cell Device,” published on May 22, 2003, which is incorporated herein by reference in its entirety. Fuels can also include liquid oxidants that react with fuels. The present invention is therefore not limited to any type of fuels, electrolytic solutions, oxidant solutions or liquids or solids contained in the supply or otherwise used by the fuel cell system. The term “fuel” as used herein includes all fuels that can be reacted in fuel cells or in the fuel supply, and includes, but is not limited to, all of the above suitable fuels, electrolytic solutions, oxidant solutions, gases, liquids, solids, and/or chemicals and mixtures thereof.

As used herein, the term “fuel supply” includes, but is not limited to, disposable cartridges, refillable/reusable cartridges, containers, cartridges that reside inside the electronic device, removable cartridges, cartridges that are outside of the electronic device, fuel tanks, fuel refilling tanks, other containers that store fuel and the tubes connected to the fuel tanks and containers. While a cartridge is described below in conjunction with the exemplary embodiments of the present invention, it is noted that these embodiments are also applicable to other fuel supplies and the present invention is not limited to any particular type of fuel supply.

The fuel supply of the present invention can also be used to store fuels that are not used in fuel cells. These applications can include, but are not limited to, storing hydrocarbons and hydrogen fuels for micro gas-turbine engines built on silicon chips, discussed in “Here Come the Microengines,” published in The Industrial Physicist (December 2001/January 2002) at pp. 20-25. As used in the present application, the term “fuel cell” can also include microengines. Other applications can include storing traditional fuels for internal combustion engines and hydrocarbons, such as butane for pocket and utility lighters and liquid propane.

Suitable known hydrogen generating apparatus are disclosed in commonly-owned, co-pending U.S. patent application Ser. Nos. 10/679,756 filed on Oct. 6, 2003; 10/854,540, filed on May 26, 2004; 11/067,167, filed on Feb. 25, 2005; and 11/066,573, filed on Feb. 25, 2005. The disclosure of these references is incorporated herein by reference in their entireties.

The gas-generating apparatus of the present invention may include a reaction chamber having a first reactant and a second reactant. The first and second reactants can be a metal hydride, e.g., sodium borohydride, and water. Both reactants can be in gaseous, liquid, aqueous or solid form. Preferably, the solid reactant is a solid metal hydride or metal borohydride, and the fluid reactant stored in the reaction chamber is water optionally mixed with additives and catalysts. One of the reactants may include methyl clathrates, which essentially include methanol enclosed or trapped inside other compounds. Water and metal hydride of the present invention react to produce hydrogen gas, which can be consumed by a fuel cell to produce electricity. Other suitable reactants or reagents are discussed below, and are also disclosed in U.S. patent application Ser. No. 10/854,540, previously incorporated by reference above.

Additionally, the gas-generating apparatus can include a device or system that is capable of controlling the release of the second reactant or combining of the two reactants. The operating conditions inside the gas-generating apparatus, preferably a pressure, are capable of controlling the release of the second reactant in the reaction chamber. For example, the second reactant can be released when the pressure inside the reaction chamber is less than a predetermined value. The release of the second reactant is preferably self-regulated. Thus, when the reaction chamber reaches or exceeds a predetermined pressure, the release of the second reactant can be halted to stop the production of hydrogen gas. Similarly, when the pressure of the reaction chamber is reduced below the predetermined pressure, the second reactant can again be released into the reaction chamber. The second reactant in the reservoir can be released by indexing mechanism, supply and take-up reels, ratcheting mechanism, or among others. Preferably, when using a solid metal hydride fuel, such as sodium borohydride, the solid fuel component is introduced into the liquid or gas fuel component, as described in the embodiments below.

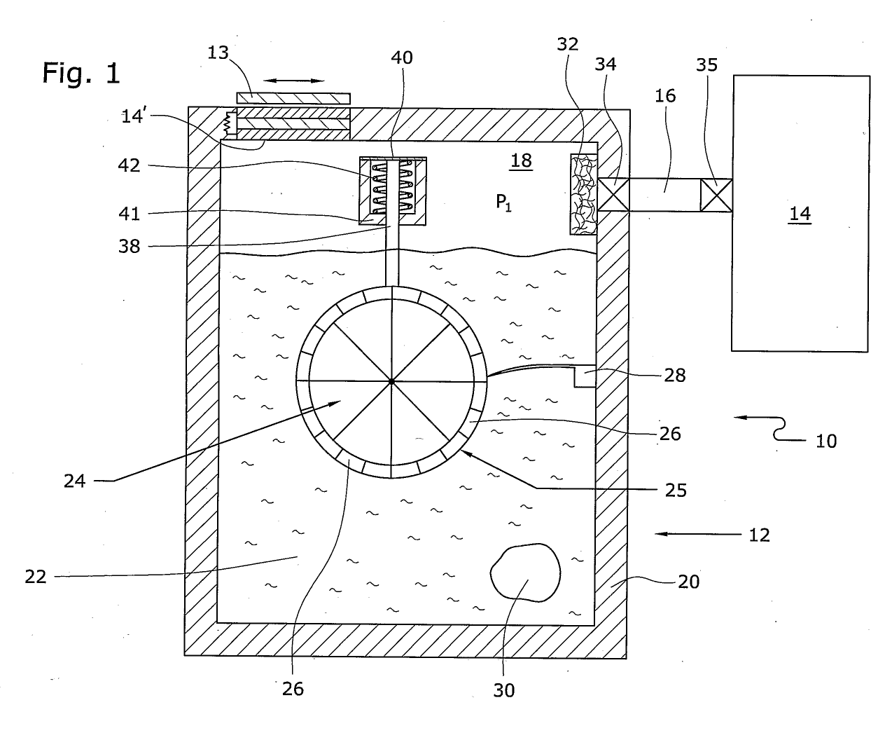

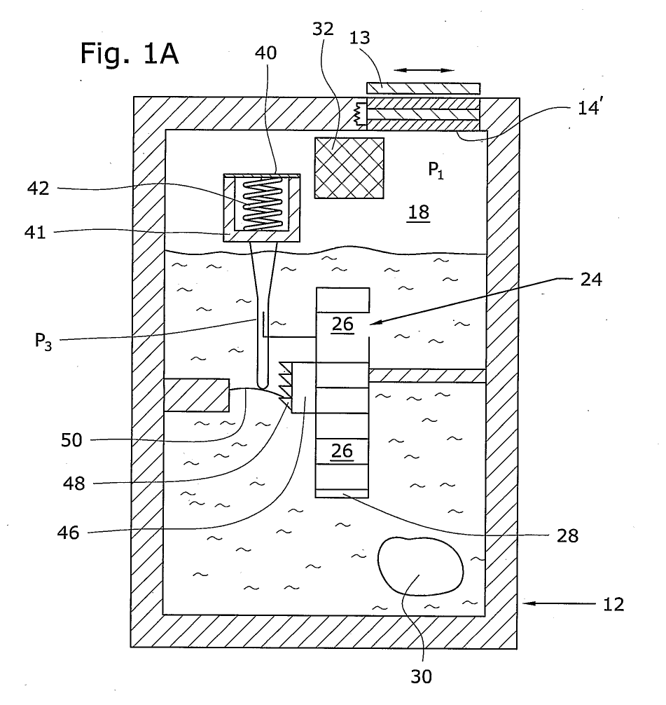

Referring to FIG. 1, a fuel supply system 10 is shown. System 10 includes a gas-generating apparatus 12 connected to a fuel cell 14. A fuel conduit 16 transfers fuel, such as hydrogen gas, to fuel cell 14. Fuel conduit 16 may be any type of fuel conduit known in the art, such as a plastic or non-reactive metal pipe or tube.

Gas-generating apparatus 12 generally includes a reaction chamber 18 enclosed within sidewalls 20. Reaction chamber 18 is at least partially filled with a fluid fuel component 22. Fluid fuel component 22, which is preferably a liquid but may also be a gas, preferably comprises an agent that is capable of reacting with a hydrogen-bearing fuel, with or without an optional catalyst, to generate hydrogen gas. Fluid fuel component 22 may also contain hydrogen. Preferably, fluid fuel component 22 includes, but is not limited to, water, alcohols, and/or dilute acids. The most common source of the agent in fluid fuel component 22 is water; however, one skilled in the art would understand that other types of agents may also be used in the present invention.

In this embodiment, an indexing wheel 24 is disposed within reaction chamber 18. Indexing wheel 24 is preferably submerged or partially submerged within fluid fuel component 22. Indexing wheel 24 is any appropriate type of wheel known in the art, made, for example, from non-reactive metals, such as stainless steel, plastics, or similar rigid materials inert to fluid fuel component 22. Indexing wheel 24 is rotatably attached to at least one of sidewalls 20. Indexing wheel 24 is ratcheted, i.e., indexing wheel 24 is able to turn only in one direction. Indexing wheel 24 includes any appropriate ratcheting mechanism known in the art, such as unidirectional stops, sloped teeth and a pawl, or similar mechanisms (not shown).

A plurality of sealed pouches 26 are disposed on an outer surface of indexing wheel 24. Sealed pouches 26 contain a solid fuel component, preferably sodium borohydride, NaBH₄, preferably in powder, granular, or tablet form. However, one skilled in the art would understand that other types of solid fuel components may also be used in the present invention. For example, sealed pouches 26 may be formed on a tape 25 that is adhered to the circumference of indexing wheel 24.

A releasing mechanism 28 is also contained within reaction chamber 18. Releasing mechanism 28 is fixedly attached at one end thereof to one of sidewalls 20, while an opposite end of releasing mechanism 28 is preferably configured with a sharp cutting or puncturing surface. Preferably, releasing mechanism 28 is configured such that the sharp cutting surface of releasing mechanism 28 is in contact with sealed pouches 26. As indexing wheel 24 is turned, the sharp cutting surface of releasing mechanism 28 opens sealed pouches 26 sequentially, which introduces the contained solid fuel component into fluid fuel component 22. Releasing mechanism 28 may be any appropriate releasing mechanism known in the art, such as a knife, blade, needle, or similar sharp object made from a rigid material such as non-reactive metal or plastic. Releasing mechanism 28 may have a smooth or serrated-edged cutting surface, a sharply pointed tip, or the like. In one exemplary embodiment, the serrated-edge cutting surface is a movable cutting surface, capable of moving or vibrating side-to-side and may be powered by a power source, such as a battery or fuel cell 14.

The size of indexing wheel 24 generally determines the amount of fuel that can be made available in reaction chamber 18. Releasing mechanism 28 opens only those sealed pouches 26 moved past releasing mechanism 28 with each indexed movement of indexing wheel 24. The size of indexing wheel 24, i.e., the diameter of indexing wheel 24, is selected so that a preferred distance along the circumference of indexing wheel 24 is traversed with each indexed movement of indexing wheel 24. Further, the larger the circumference of indexing wheel 24, the larger the number of sealed pouches 26 that may be placed on the outer surface of indexing wheel 24. Preferably, the size of indexing wheel 24 is small enough to fit entirely inside reaction chamber 18.

Alternatively, pouches 26 may be positioned on a side face of the wheel 24 spiraling towards the center. Releasing mechanism 28 is positioned perpendicular to the wheel. In addition, pouches 26 may be positioned on the inner and outer faces of wheel 24 with releasing mechanisms 28 placed above and below wheel 24. Wheel 24 may then be geared according to any method known in the art such that pouches 26 on opposing faces of wheel 24 are alternately opened.

Once released into fluid fuel component 22, the solid fuel component reacts with fluid fuel component 22 to produce hydrogen gas for use in fuel cell 14. The reaction between the solid fuel component and fluid fuel component 22 is described in detail in the '167 and '573 applications, previously incorporated by reference. As more and more gas is produced, the pressure within reaction chamber 18, designated as P₁, can be relieved by transferring the produced gas through fuel conduit 16 and into fuel cell 14. An optional pressure relief valve, not shown, may also be included in case pressure P₁ exceeds a threshold value.

A check valve 34 is provided at or near the interface of fuel conduit 16. Check valve 34 helps to control the flow of gas into and out of gas-generating apparatus 12 and may be used to seal gas generating apparatus 12. For example, check valve 34 may be a unidirectional valve that allows gas to flow from gas generating apparatus 12 into fuel conduit 16 but not in the reverse direction. Additionally, check valve 34 is preferably automatically opened when pressure P₁ within reaction chamber 18 reaches a threshold level P₂; any pressure below threshold level P₂ causes check valve 34 to close and prevent additional flow of gas out of reaction chamber 18.

Optionally, a gas-permeable, liquid impermeable membrane 32 such as, for example, Gore-Tex®, is positioned over valve 34 to prevent potentially damaging liquid from entering fuel cell 14. Conduit 16 is also preferably sealed with another valve, e.g., shut-off valve 35, located downstream that can be opened by the fuel cell when hydrogen is needed.

The motion of indexing wheel 24 is preferably automatically controlled by pressure P₁, the internal pressure of reaction chamber 18, triggering the ratcheting system which controls the turning of wheel 24. The ratcheting system may be any known ratcheting system in the art. One example of an appropriate ratcheting system is shown in FIGS. 1 and 1A, where a spring-loaded diaphragm 40, such as rubber or urethane membrane, is sealingly disposed within a chamber 41 and attached therein to a spring 42. Diaphragm 40 is a pressure sensitive diaphragm and is exposed to P₁, the gas pressure within reaction chamber 18. Spring 42 provides a biasing force K to bias diaphragm 40 away from wheel 24. Pressure P₁ and biasing force K oppose one another so that when pressure P₁ is greater than biasing force K, diaphragm 40 flexes toward wheel 24. Similarly, when pressure P₁ is less than biasing force K, spring 42 pushes diaphragm 40 away from wheel 24. As shown in FIG. 1A, chamber 41 is preferably open to the atmosphere to prevent a vacuum from forming therewithin and to allow the pressure behind diaphragm 40 to equalize. Alternatively, chamber 41 may be sealed and contain a liquefied natural gas such as butane. The liquefied natural gas can replace spring 42 or apply an additional force in addition to spring 42.

Diaphragm 40 is fixedly attached to a rod 38, so that the movement of diaphragm 40 due to the opposing forces of reaction chamber pressure P₁ and spring force K moves rod 38. The other end of rod 38 is attached to a pawl such as a spring arm 50. Spring arm 50 is preferably a thin flexible member made from a non-reactive metal or plastic with one end thereof fixedly attached to sidewall 20 and the other end thereof engaged with an indexing mechanism 46.

Indexing mechanism 46 is fixedly attached to indexing wheel 24 and preferably contains a plurality of downwardly-angled teeth 48. Teeth 48 are preferably shaped with a smooth outer surface so that spring arm 50 is relatively easily pushed over the top of each tooth 48 so that spring arm 50 may catch underneath it. The size of each tooth 48 is selected so that indexing wheel 24 rotates a fixed amount for each movement of a single tooth 48.

When reaction chamber pressure P₁ is less than spring force K exerted by spring 42, spring 42 pushes/pulls diaphragm 40 away from wheel 24. Rod 38 is lifted and, in turn, lifts spring arm 50. Since the free end of spring arm 50 is caught beneath one of teeth 48, the lifting of spring arm 50 turns wheel 24. When reaction chamber pressure P₁ is greater than spring force K exerted by spring 42, diaphragm 40 biases rod 38 toward wheel 24 so that the free end of spring arm 50 is advanced over and catches beneath another tooth 48 in anticipation of the next need for a new infusion of fuel.

The pressure cycle that triggers the ratcheting system controlling the motion of indexing wheel 24 is summarized in Table 1 and is further described below.

TABLE 1
Pressure Cycle in Gas Generating Apparatus

| | | | Shut-off Valve 35 | Transfer of Gas |
|---|---|---|---|---|
| Pressure and | Effect on | Effect on | Controlled by Fuel | From Reaction |
| Force | Ratchet | Fuel Cell | Cell when fuel is | Chamber 18 and |
| Relationships | System | Valve 34 | required | Fuel Cell 14 |
| P₁ < K | Rod 38 is lifted, | CLOSED | If Closed | No flow |
| P₁ < P₂ | thereby | | If Open | No flow |
| | allowing spring | | | |
| | arm 50 to turn | | | |
| | wheel 24 and | | | |
| | introduce new | | | |
| | solid fuel | | | |
| | component into | | | |
| | liquid fuel | | | |
| | component | | | |
| P₁ ≦ K | No movement - | CLOSED | If closed - no flow | No flow, gas |
| P₁ < P₂, after | Rod 38 remains | | If open - no flow | pressure builds |
| introduction | lifted | | | within reaction |
| of solid fuel | | | | chamber 18 |
| component | | | | |
| into liquid | | | | |
| fuel | | | | |
| component 22 | | | | |
| P₁ ≦ K | Rod 38 remains | OPEN | If closed - no flow | Gas flows (if |
| P₁ ≧ P₂ | lifted | | If open - flow | shut-off valve is |
| | | | | open - fuel cell |
| | | | | wants fuel) |
| P₁ > K | Rod 38 is | OPEN | If closed - no flow | Gas flows (if |
| P₁ > P₂ | pushed toward | | If open - flow | shut-off valve is |
| | wheel 24 | | | open - fuel cell |
| | advancing | | | wants fuel) |
| | spring arm 50 | | | |
| | over the next | | | |
| | tooth 48 | | | |
| P₁ > K | Rod 38 is | CLOSED | If closed - no flow | No flow, pressure |
| P₁ < P₂ | lowered | | If open - no flow | can build |

Initially, reaction chamber pressure P₁ can be made to be sufficient to lower rod 38 onto spring arm 50. This may be accomplished by any method known in the art. For example, once system 10 is assembled, a predetermined amount of an initializing inert gas or hydrogen may be injected into reaction chamber 18 via, for example, valve 34 or any other means. Preferably, the predetermined amount of the inert gas or hydrogen is sufficient for rod 38 to exert sufficient force on spring arm 50 to prevent spring arm 50 from returning to its neutral state and, therefore, preventing indexing wheel 24 from turning. Also, preferably reaction chamber pressure P₁ is initially high enough to open check valve 34 to start the flow of gas to fuel cell 14 when shut-off valve 35 is opened. As the gas in reaction chamber 18 is transferred to fuel cell 14 through conduit 16, reaction chamber pressure P₁ decreases.

Once reaction chamber pressure P₁ dips below spring force K, spring 42 expands, and diaphragm 40 flexes. Rod 38 is drawn upward so that it lifts spring arm 50. As the free end of spring arm 50 is engaged with tooth 48, spring arm 50 carries/moves tooth 48 along with its motion, thereby turning indexing wheel 24. As indexing wheel 24 is turned, the sharp edge of releasing mechanism 28 cuts, splits, or pierces open at least one of sealed pouches 26, and the contained fuel component is introduced into fluid fuel component 22 to produce hydrogen gas. As reaction chamber pressure P₁ again builds within reaction chamber 18 due to the new gas production, reaction chamber pressure P₁ increases until reaction chamber pressure P₁ exceeds K so that reaction chamber pressure P₁ overcomes the force of spring 42 and, via diaphragm 40, lowers rod 38. Rod 38 once again pushes on spring arm 50, thereby forcing the tip of spring arm 50 over the edge of at least one of teeth 48 of structure 46 in preparation for the next turn of wheel 24.

Threshold level P₂ and spring force K are carefully selected so that the automatic operation of gas generating apparatus is not interrupted. Preferably, spring force K is very slightly less than threshold level P₂. In such a case, spring 42 will lift rod 38 just prior to the closing of valve 34.

Alternatively, a mechanism such as an external button may be depressed by a user to open a first pouch to start the reaction.

Alternatively, indexing wheel 24 may be controlled electronically by a controller, such as, for example, a microprocessor connected to fuel cell 14 that controls a motor driving indexing wheel 24 (not shown). The controller in this alternative embodiment may monitor the P₁ using sensors in reaction chamber 18. The pressure sensor may be any type of pressure sensor known in the art that is capable of being placed in reaction chamber 18 and measuring pressure in the anticipated range of approximately 0-100 psi, although this range may vary depending upon the fuel cell system and fuel used. For example, the pressure sensor may be a pressure transducer available from Honeywell, Inc. of Morristown, N.J. The pressure sensor may also be a glass or silica crystal that behaves like a strain gauge, i.e., the crystal emits a current depending upon the amount of pressure. Another example of an appropriate sensor for sensing the pressure within reaction chamber 18 is a piezoelectric sensor. Piezoelectric sensors are solid state elements that produce an electrical charge when exposed to pressure or to impacts. Suitable piezoelectric sensors are available from many sources, including PCB Piezotronics of DePew, N.Y.

In another embodiment, check valve 34 is omitted from apparatus 10 and threshold pressure P₂ is no longer a factor. In this embodiment, when shut off valve 35 is closed, pressure P₁ of reaction chamber 18 would exceed spring force K to stop the movement of wheel 24, discussed above. When valve 35 is open, pressure P₁ is reduced to allow the indexing of wheel 24. A pressure regulator can be positioned between the gas-generating apparatus 10 and fuel cell 14 to regulate the output of hydrogen. Suitable pressure regulators are disclosed in commonly owned U.S. patent application “Hydrogen-Generating Fuel Cell Cartridges,” bearing Ser. No. 11/327,580, filed on Jan. 6, 2006. This application is incorporated herein by reference in its entirety.

Optional liquid impermeable, gas permeable layer/membrane 32 allows the passage of gases, such as hydrogen gas, out of the apparatus, and at the same time keeps liquid within reaction chamber 18. Membrane 32 may be formed from any liquid impermeable, gas permeable material known to one skilled in the art. Such materials can include, but are not limited to, hydrophobic materials having an alkane group. More specific examples include, but are not limited to: polyethylene compositions, polytetrafluoroethylene, polypropylene, polyglactin (VICRY®), lyophilized dura matter, or combinations thereof. Gas permeable member 30 may also comprise a gas permeable/liquid impermeable membrane covering a porous member. Examples of such membrane are CELGARD® and GORE-TEX®. Other gas permeable, liquid impermeable members usable in the present invention include, but are not limited to, SURBENT® Polyvinylidene Fluoride (PVDF) having a porous size of from about 0.1 μm to about 0.45 μm, available from Millipore Corporation. The pore size of SURBENT® PVDF regulates the amount of water exiting the system. Materials such as electronic vent-type material having 0.2 μm hydro, available from W. L. Gore & Associates, Inc., may also be used in the present invention. Additionally, 0.25 inch diameter rods having a pore size of about 10 μm or 2 inch diameter discs with a thickness of about 0.3 μm available from GenPore, and sintered and/or ceramic porous material having a pore size of less than about 10 μm available from Applied Porous Technologies Inc. are also usable in the present invention. Furthermore, nanograss materials, from Bell Labs, are also usable to filter the liquid. Nanograss controls the behavior of tiny liquid droplets by applying electrical charges to specially engineered silicon surfaces that resemble blades of grass. Additionally, or alternatively, the gas permeable, liquid impermeable materials disclosed in commonly owned, co-pending U.S. patent application Ser. No. 10/356,793 are also usable in the present invention, all of which are incorporated herein by reference in their entireties. Such a membrane 32 may be used in any of the embodiments discussed herein. In addition, a filler or foam may be placed over membrane 32 to minimize clogging of the membrane with byproducts or slurry.

A pressure reduction pouch 30 is preferably placed in reaction chamber 18 and, more preferably, submerged within fluid fuel component 22. Pressure reduction pouch 30 is made of a material that is able to release its contents when the pressure in reaction chamber 18 reaches a predetermined value. For example, pressure reduction pouch 30 may be formed from a membrane that allows passage of its contents through its sidewalls when under a predetermined pressure. Alternatively, pressure reduction pouch 30 may be formed from a material that ruptures under a predetermined pressure. Preferably, when hydrogen gas is being produced, pressure reduction pouch 30 includes at least one composition that raises the pH of fluid fuel component 22. Raising the pH of fluid fuel component 22 lowers the reaction rate to the point where almost no hydrogen evolves. In other words, the introduction of the contents of pressure reduction pouch 30 neutralizes the system. Accordingly, the contents of pressure reduction pouch 30 is, preferably, a basic composition having a pH greater than about 7, preferably from about 9 to about 14. An exemplary composition that is appropriate for use in pressure reduction pouch 30 is sodium hydroxide. Additionally, the contents of pressure reduction pouch 30 may be in a solid form, such as powder, or in a liquid form. Such a pressure reduction pouch 30 may be used in any of the embodiments described herein.

Another device to control the pressure of reaction chamber 18 is to place a secondary fuel cell 14′ on a sidewall 20, as shown in FIG. 1. Secondary fuel cell 14′ consumes excess hydrogen to minimize pressure P₁ when shut-off valve 35 is closed. As shown, secondary fuel cell 14′ is positioned on one of sidewalls 20 with the anode side facing the reaction chamber 18 and in contact with hydrogen gas and with the cathode side facing the ambient air and in contact with oxygen. Preferably, a movable cover gate 13 is provided to cover the cathode side when the gas-generating apparatus is in operation to prevent air from reaching fuel cell 14′ so that hydrogen is not wasted in consumption by secondary fuel cell 14′. When the user or controller opens valve 35, gate 13 is moved to cover secondary fuel cell 14′. When the user or controller closes valve 35 (or when pressure P₁ exceeds a threshold level) gate 13 is moved to allow air to contact the cathode side to consume excess hydrogen. An electrical-energy consuming device, such as a resistor or similar circuit, is provided as shown schematically to consume the electricity produced by fuel cell 14′. Secondary fuel cell 14′ and cover 13 can be used with any of the embodiments of the present invention.

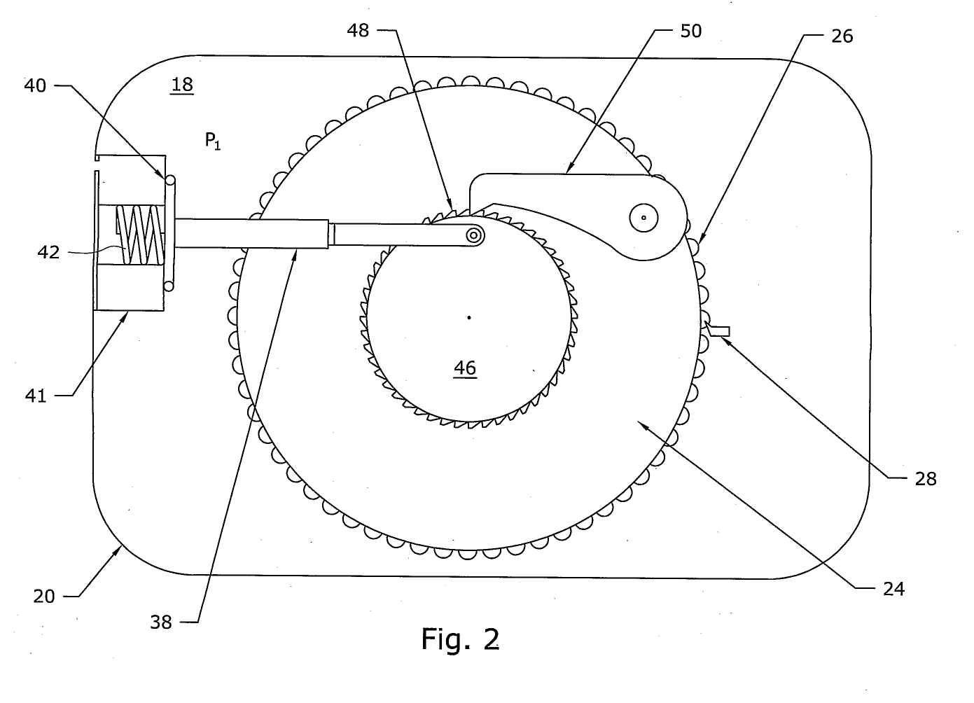

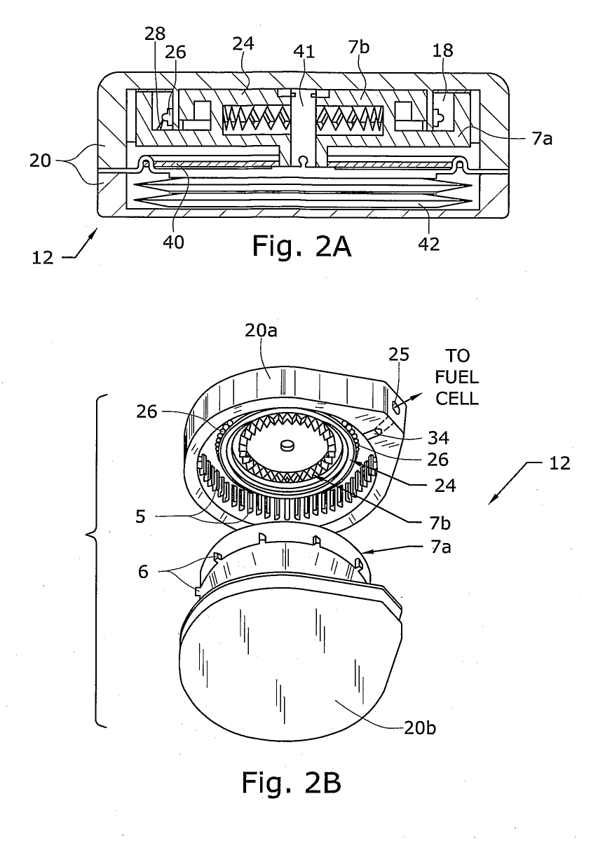

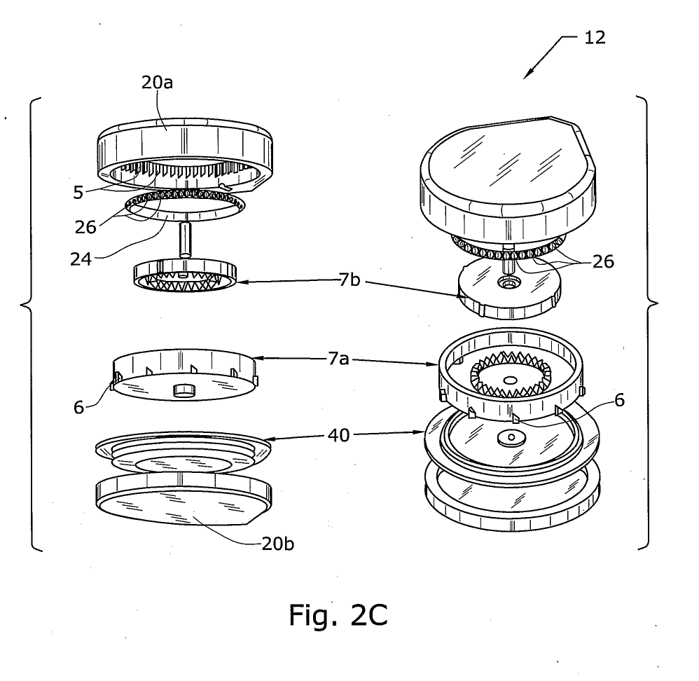

In another exemplary embodiment, as illustrated in FIG. 2, gas-generating apparatus 12 is generally similar to gas-generating apparatus 12 described with respect to FIGS. 1 and 1A, as gas generating apparatus 12 includes reaction chamber 18 with indexing wheel 24 suspended within fluid fuel component 22. Sealed pouches 26 containing a fuel component are disposed on the circumferential perimeter of indexing wheel 24. Releasing mechanism 28 is configured to open sealed pouches 26 as indexing wheel 24 turns, and spring-driven, pressure-sensitive diaphragm 40 drives rod 38 to turn indexing wheel 24. Diaphragm 40 moves as described above with respect to FIGS. 1 and 1A. When the reaction chamber pressure P₁ is less than the force from spring 42 K, diaphragm 40 is biased toward wheel 24 by spring 42. When the reaction chamber pressure P₁ is greater than the force from spring 42 K, diaphragm 40 flexes away from wheel 24.

In this embodiment, however, rod 38 is hingedly attached directly to ratcheting mechanism 46, so that as diaphragm 40 flexes as described above, rod 38 pushes on ratcheting mechanism 46. A spring-loaded pawl 50, which is hingedly attached to wheel 24, engages with one of teeth 48 so that wheel 24 is locked into position with ratcheting mechanism 46 when rod 38 pushes on ratcheting mechanism 46. In other words, wheel 24 can only turn in one direction as pawl 50 and teeth 48 act as a stop preventing wheel 24 from spinning counter-clockwise (in FIG. 2). When reaction chamber pressure P₁ is greater than the force from spring 42 K, diaphragm 40 flexes toward spring 42, pulling rod 38 toward spring 42. In turn, rod 38 pulls on ratcheting mechanism 46. Pawl 50 rotates on its hinge to pass over at least one of teeth 48. As ratcheting mechanism 46 is connected to wheel 24 only by pawl 50 and otherwise turns independently therefrom, wheel 24 does not turn as pawl 50 slips over teeth 48 in anticipation of the next need for solid fuel to be introduced into reaction chamber 18.

As reaction chamber pressure P₁ drops, diaphragm 40 is pushed toward wheel 24 by spring 42. This motion translates rod 38 toward wheel 24, thereby forcing ratcheting mechanism 46 clockwise (in this embodiment.) As pawl 50 is engaged with one of teeth 48, pawl 50 cannot slip over teeth 48. As such, the motion of ratcheting mechanism 46 pushes pawl 50, causing wheel 24 to turn. At least one of sealed pouches 26 is forced past releasing mechanism 28, thereby introducing solid fuel component into the liquid fuel component.

Yet another alternate ratcheting system is shown in FIGS. 2A-2C. In this system, similar to the embodiments described above, a housing 20 encloses a gas-generating apparatus 12. Housing 20 includes an upper portion 20a and a lower portion 20b, which are sealingly attached to each other to define an interior space 18. A port 25 is provided in upper portion 20a to fluidly connect interior space 18 to a fuel cell (not shown) or a conduit to a fuel cell (not shown). A valve 34 may be disposed between interior space 18 and port 25 so that gas is only transferred to fuel cell when the pressure within interior space 18, a fuel gas pressure P₁, reaches a threshold value. Valve 34 may be any type of unidirectional, pressure-triggered valve known in the art, but is preferably a check valve. A shutoff valve 35 (not shown in FIGS. 2A-2C) is preferably provided fluidly upstream of valve 34 so that a user may manually or a controller may automatically control the flow of fuel gas from gas-generating apparatus 12.

Also provided on an interior surface of upper housing portion 20a are a series of indexing ribs 5. Indexing ribs 5 are preferably a plurality of evenly-spaced rectangular protrusions extending outward from upper portion 20a.

Enclosed within interior space 18 in the portion defined by upper portion 20a is a ratcheted wheel 24 having a plurality of sealed pouches 26 disposed around the perimeter of ratcheted wheel 24. Sealed pouches 26 contain a fuel gas, such as hydrogen or any other fuel gas known in the art or described herein. Sealed pouches 26 may be made from any material known in the art capable of containing the fuel gas, such as plastic, glass, or other fluid-impermeable materials. Preferably, sealed pouches 26 are made thin-walled so that sealed pouches 26 may be readily punctured, broken or ruptured when necessary. A releasing mechanism 28, such as a cutting or sharply pointed needle is fixedly attached to housing 20 within interior space 18. Releasing mechanism 28 is configured to puncture, cut or break open at least one of sealed pouches 26 as sealed pouches 26 are indexed past releasing mechanism 28.

A pressure-sensitive diaphragm 40 made from any flexible material is disposed between upper portion 20a and lower portion 20b. Diaphragm 40 is spring-loaded, with a spring 42 being provided within lower portion 20b. Spring 42 may be any type of spring known in the art which is capable of biasing diaphragm 40 toward wheel 24, such as a coiled compression spring or stacked spring washers.

A rotating plunger 7a is rotatably connected to diaphragm 40 via a link pin 41, as shown in FIG. 2A. Rotating plunger 7a includes a plurality of gear teeth which interconnect and engage with a plurality of gear teeth provided on a translating plunger 7b. Disposed on an exterior surface of rotating plunger 7a are a series of indexing tabs 6. Indexing tabs 6 are protrusions extending outward from rotating plunger 7a, where one sidewall of each indexing tab 6 is angled. Also, indexing tabs 6 are preferably relatively shorter in length than indexing ribs 5 and extend from the interface of rotating plunger 7a and diaphragm 40 only partially over the height of rotating plunger 7a. Indexing tabs 6 are configured to interlock and engage with indexing ribs 5 on upper housing portion 20a. Preferably, fewer indexing tabs 6 are provided than indexing ribs 5.

In operation, interior space 18 is initially charged, such as with a charge of the fuel gas also stored in sealed pouches 26, so that fuel gas pressure P₁ is high enough to open valve 34 when the shutoff valve (not shown) is opened. Fuel gas pressure P₁ is also sufficiently high to flex diaphragm 40 toward lower housing portion 20b and compress spring 42.

As diaphragm 40 deflects from fuel gas pressure P₁, translating plunger 7b moves in the same direction, i.e., toward lower housing portion 20b. As rotating plunger 7a is engaged with translating plunger 7b, rotating plunger 7a also translates in the same direction. Indexing tabs 6 slide along indexing ribs 5. Indexing ribs 5 are eventually forced over the angled surface on indexing tabs, causing rotating plunger 7a to turn. As rotating plunger 7a is engaged with translating plunger 7b, translating plunger 7b, and, therefore, wheel 24, also rotate on link pin 41. As wheel 24 turns, at least one of sealed pouches 26 is forced past and opened by releasing mechanism 28. Fuel gas pressure P₁ may continue to build with the release of new gas from sealed pouches 26, if the withdrawal of gas from interior space 18 through valve 34 is slower than the addition of gas from sealed pouches 26.

As the pressure continues to increase, indexing tabs 6 are freed from indexing ribs 5, and one complete indexing motion of wheel 24 is achieved. As fuel gas is consumed and/or transferred through valve 34 and fuel gas pressure P₁ is reduced, spring 42 pushes against diaphragm 40 to translate rotating plunger 7a back toward and re-engage with translating plunger 7b in anticipation of the next indexing movement.

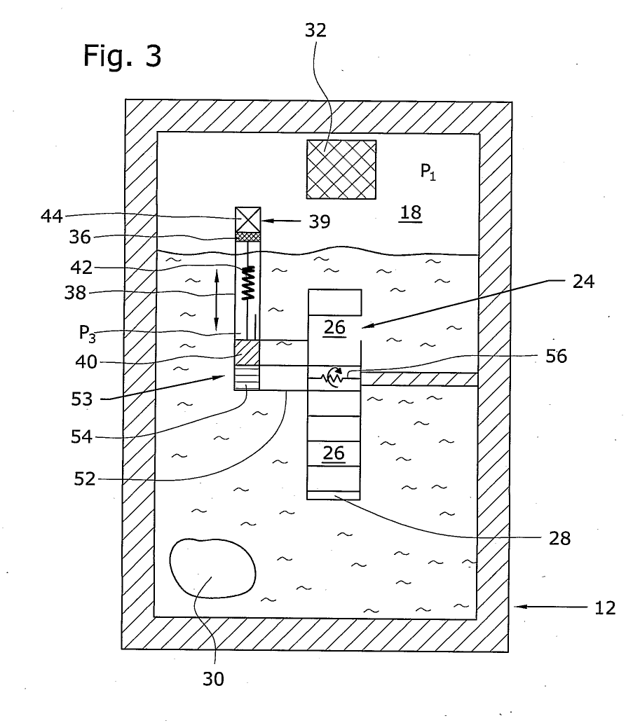

In another exemplary embodiment, as illustrated in FIG. 3, gas-generating apparatus 12 is generally similar to gas-generating apparatus 12 described with respect to FIGS. 1 and 1A, as gas generating apparatus 12 includes reaction chamber 18 with indexing wheel 24 suspended within fluid fuel component 22. Sealed pouches 26 containing a fuel component are disposed on the circumferential perimeter of indexing wheel 24. Releasing mechanism 28 is configured to open sealed pouches 26 as indexing wheel 24 turns. In this embodiment, however, a shaft 52 protrudes from indexing wheel 24 at or near the center of wheel 24. Shaft 52 is preferably a rigid rod-like member made from a non-reactive metal, such as stainless steel, or a plastic. The free end 53 of shaft 52 is configured with slots or teeth 54 so that free end 53 of shaft 52 somewhat resembles a gear.

A rotational spring 56 is attached to indexing wheel 24. Rotational spring 56 may be any type of spring known in the art that is capable of turning indexing wheel 24. For example, rotational spring 56 may be a wound torsion or clock spring. Rotational spring 56 exerts a rotational force on wheel 24 and is preferably located within a center pocket of indexing wheel 24 (not shown).

As in the embodiment discussed above with respect to FIGS. 1 and 2, piston 40 is sealingly disposed within piston chamber 38 and suspended therewithin by a spring 42 which biases piston 40 toward an upper end 39 of piston chamber 38. In this embodiment, the lower end of piston 40 is preferably configured to engage with slots 54. For example, the lower end of piston 40 may be pointed or have a wedge-like shape. When the pressure in reaction chamber 18, P₁, is greater than the pressure in piston chamber 38, P₃, gas flows into piston chamber 38 to increase P₃. When piston chamber pressure P₃ exceeds the force exerted by spring 42, K, piston 40 is lowered so that the lower end of piston 40 engages with slots 54, thereby preventing further rotational movement of indexing wheel 24. In other words, piston 40 locks wheel 24 into place.

In operation, reaction chamber 18 is preferably initially pressurized, as described above with respect to the first embodiment. As such, piston 40 is in a lowered position so that wheel 24 is locked. Check valve 34 is opened upon connection of gas generating apparatus 12 to fuel cell 14 and after shut-off valve 35 is opened, so reaction chamber pressure P₁ starts to decrease. As reaction chamber pressure P₁ decreases, the gas within piston chamber 38 flows into reaction chamber 18, thereby decreasing piston chamber pressure P₃. When enough gas has transferred from piston chamber 38 into reaction chamber 18 to decrease piston chamber pressure P₃ to the extent that piston chamber pressure P₃ is less than spring force K, spring 42 returns to its neutral state, thereby raising piston 40. Index wheel 24 is then free to turn due to the rotational force provided by rotational spring 56. At the same time, reaction chamber pressure P₁ may reduce to the point that the pressure required to hold open check valve 34, P₂, is no longer available. Check valve 34 closes, thereby shutting off the further flow of gas from reaction chamber 18 to fuel cell 14.

Similar to FIG. 2, as indexing wheel 24 turns, the sharp edge of releasing mechanism 28 opens sealed pouch 26, thereby introducing the contained fuel component into fluid fuel component 22 to produce a gas, as described above with respect to FIG. 1. Reaction chamber pressure P₁ increases due to the production of new gas, and gas begins to flow into piston chamber 38. As such, piston chamber pressure P₃ increases. Reaction chamber pressure P₁ eventually exceeds threshold pressure P₂, thereby once again opening check valve 34. Once piston chamber pressure P₃ exceeds K, piston 40 is again lowered to engage with slots 54 and prevent further turning of indexing wheel 24. This cycle is summarized below in Table 2.

TABLE 2
Pressure Cycle for Spring-Driven Wheel

| | | | | Transfer of |
|---|---|---|---|---|
| | Transfer of Gas | | | Gas From |
| | Between Piston | | | Reaction |
| Pressure and | Chamber 38 and | | Effect on | Chamber 18 |
| Force | Reaction | Effect on Ratchet | Check Valve | and Fuel Cell |
| Relationships | Chamber 18 | System | 34 | 14 |
| P₁ > P₃ | Gas flows from | Piston 40 is in | OPEN | Gas flows |
| P₃ > K | reaction chamber | lowered position, no | | |
| P₁ > P₂ | 18 into piston | turning of wheel 24 | | |
| | chamber 38 | | | |
| P₁ ≧ P₃ | Gas flows into or | Piston 40 stays | OPEN | Gas flows |
| P₃ > K | stays within piston | lowered onto spring | | |
| P₁ ≧ P₂ | chamber 38 | arm 50 | | |
| P₁ < P₃ | Gas flows from | Piston 40 stays | CLOSED | No flow |
| P₃ > K | piston chamber 38 | lowered onto spring | | |
| P₁ < P₂ | into reaction | arm 50 | | |
| | chamber 18 | | | |
| P₁ < P₃ | No flow, gas | Piston 40 lifted by | CLOSED | No flow, gas |
| P₃ < K | builds pressure | spring 42, wheel 24 | | pressure builds |
| P₁ < P₂ | within reaction | turns, gas production | | within reaction |
| | chamber 18 | begins | | chamber 18 |

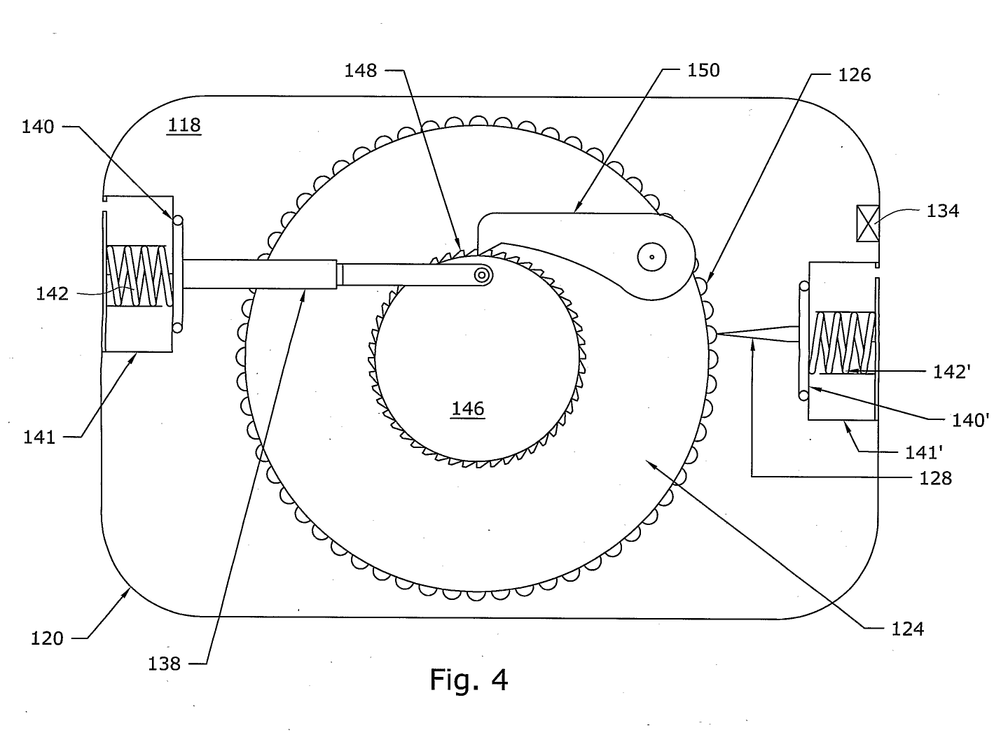

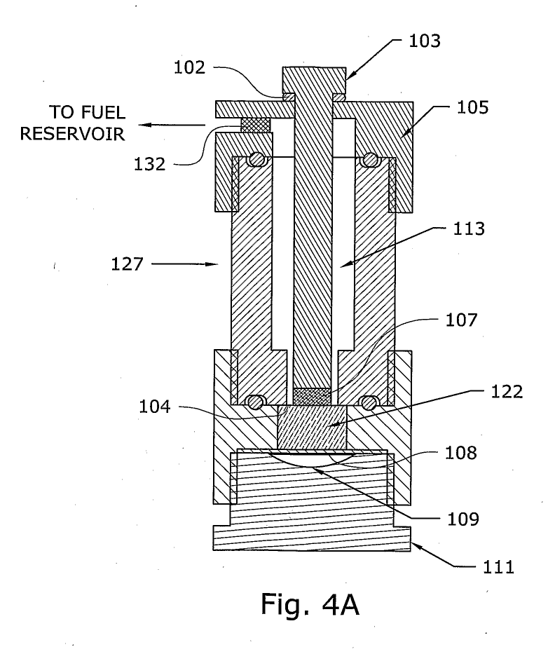

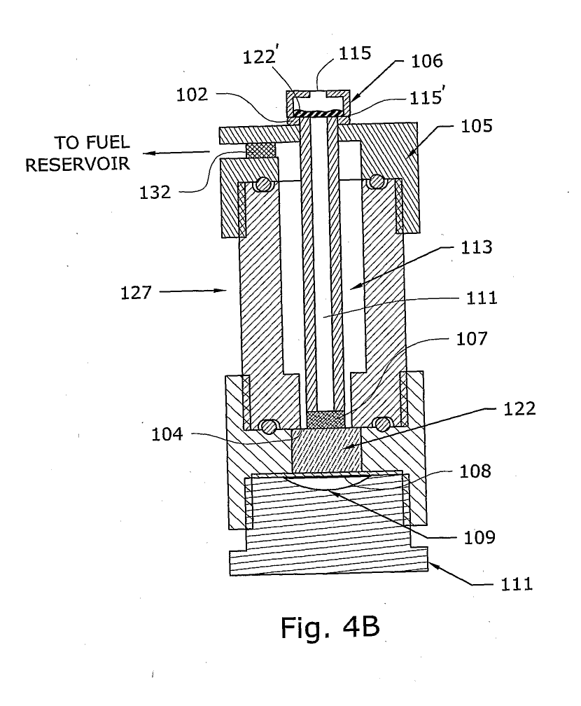

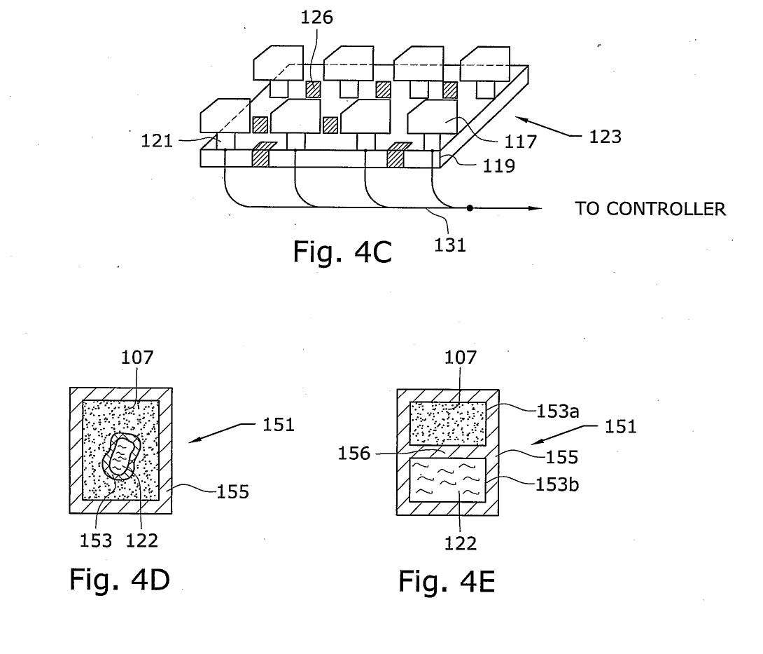

Referring to FIG. 4, another alternative gas-generating apparatus is shown. In this embodiment, an indexing wheel 124 having a plurality of solid-fuel pouches 126 disposed on an outer surface thereof is ratcheted using a spring mechanism 141 having a spring-loaded diaphragm 140 attached to a biasing spring 142 to drive a rod 138 which turns a ratcheting mechanism 146 as described above with respect to FIG. 2. Also the same as the embodiment in FIG. 2, a spring-loaded pawl 150 which is hingedly attached to wheel 124 engages with teeth 148 on ratcheting mechanism 146 to allow wheel 124 to turn only in one direction.

However, in this embodiment, a second spring mechanism 141′ is used to move a puncturing element 128 toward wheel 124 when a fuel pouch 126 is positioned to be pierced. As with spring mechanism 141, second spring mechanism 141′ has a pressure-sensitive diaphragm 140′ exposed to reaction chamber pressure P₁ and a biasing spring 142 to provide a spring force K′ to oppose reaction chamber pressure P₁. When reaction chamber pressure P₁ is greater than spring force K′, piercing element 128 is held away from wheel 124 and pouches 126 due to the force of reaction chamber pressure P₁ pushing against diaphragm 140′. When spring force K′ is greater than reaction chamber pressure P₁, piercing element 128 is pushed towards wheel 124 and pouches 126 by spring 142′. Preferably, spring 142′ is slightly weaker than spring 142 so that wheel 124 is turned before piercing element 128 is pushed toward wheel 124.

Indexing wheel 124 and pressure-driven piercing mechanism 128 can also be used when pouches 126 are replaced by fuel-producing pods 127 as shown in FIGS. 4A and 4B. In this embodiment, a fuel reservoir (not shown) is provided to hold the fuel, such as hydrogen gas, produced by pods 127. Fuel reservoir may be located on either the fuel supply or the fuel cell side. Each pod 127 includes a portion of solid fuel component 107 held in a chamber adjacent a chamber filled with a liquid fuel component 122. Either fuel component may be any fuel component described herein, such as using sodium borohydride for solid fuel component 107 and water or a solution containing water as liquid fuel component 122. Preferably, the proportion of solid fuel component to liquid fuel component is such that all of the solid fuel component reacts. Even more preferably, only sufficient liquid fuel component is provided in order to react all of the solid fuel component; in other words, the amount of sold fuel component is stoichiometrically linked as close to one-to-one as practicable with the liquid fuel component. Production of hydrogen close to stoichiometric limits is discussed in commonly owned U.S. patent application entitled “Fuels for Hydrogen Generating Apparatus,” bearing Ser. No. 60/689,572, filed on Jun. 13, 2005. This application is incorporated herein by reference in its entirety.

Solid fuel component 107 and liquid fuel component 122 are separated by a thin frangible membrane 104. A rod 103 is in contact with solid fuel component 107, extends through a fuel conduit 113, and out of pod 127 through a cap 105. Rod 103 can move toward solid fuel component 107 a small amount when impacted by a sufficient force. O-ring 102 cushions the impact. For example, if pressure changes in the system are sudden, rod 103 will experience a striking impact. However, it is also anticipated that reactions may take place much more slowly, in which case rod 103 will experience a gradual force and not an impact.

When rod 103 is struck, such as by pressure-driven piercing mechanism 128, rod 103 pushes solid fuel component through frangible membrane 104 into liquid fuel component 122. Preferably, a void 109 is provided below liquid fuel component 122 and separated therefrom by a flexible membrane 108, such as a thin sheet of rubber or urethane. Void 109 allows the greater volume of liquid fuel component 122 due to the addition of solid fuel component 107 to expand adequately.

As fuel components 107, 122 react, fuel gas is produced. The fuel travels through fuel conduit 113 and out to the reservoir (not shown) to replenish the fuel gas therewithin, and raise reaction chamber pressure P₁. When reaction chamber pressure P₁ becomes sufficiently low again so that wheel 124 is turned as described above with respect to FIG. 2, spent pod 127 is moved out of position and a fresh pod 127 is aligned with pressure-driven piercing mechanism 128. An optional gas permeable, liquid impermeable membrane 132 may be provided to prevent liquid from being transferred to the fuel cell. Membrane 132 may be any type of gas permeable, liquid impermeable membrane known in the art, such as those described above with respect to FIG. 1.

An alternate fuel-producing pod 127′ is shown in FIG. 4B. In this embodiment, which is similar to the embodiment shown in FIG. 4A, solid fuel component 107 is positioned at a first end of a stationary fluid conduit 111. A second end of fluid conduit 111 terminates at a fluid reservoir 106 which is situated on cap 105. Fluid reservoir 106 contains a small amount of charging liquid fuel component 122′, which is preferably the same composition as liquid fuel component 122. Fluid reservoir 106 includes two frangible membranes 115, 115′ which are aligned with each other on opposite sides of fluid reservoir 106.

When pushed toward wheel 124, pressure-driven piercing mechanism 128 pierces both frangible membranes 115, 115′, charging liquid fuel component 122′ which passes through fluid conduit 111 to react with solid fuel component 107. The fuel gas produced creates sufficient pressure within fluid conduit 111 to push solid fuel component 107 through frangible membrane 104 and into liquid fuel component 122. As will be recognized by those in the art, a sufficient quantity of charging liquid fuel component 122′ may be provided to react all of solid fuel component 107. In this case, liquid fuel component 122 may be eliminated.

As will be recognized by those in the art, charging fuel component 122′ may be housed in any type of frangible or breakable container known in the art, such as a capsule made of glass, plastic, or the like. Additionally, instead of a reservoir such as reservoir 106, charging fuel component 122′ could be contained within a plurality of chambers 117 of an array, such as a micro-machined array 123 as shown in FIG. 4C. Chambers 117 are preferably mounted onto a mesh-like substrate 119, such as a sheet of glass or plastic with a number of holes 126 therethrough. Chambers 117 are preferably mounted to substrate 119 by a deformable material 121 that deforms in a known way when exposed to an electrical signal, such as piezoelectric material or an electro-active polymer. Deformable material 121 is preferably linked to a controller such as a microprocessor or microchip via leads 131. When the controller senses a change in the pressure, such as by receiving a signal from a pressure sensor (not shown), the controller sends an electrical signal to one of chambers 117. When the signal passes through deformable material 121, deformable material 121 bends to tilt chamber 117. Alternatively, deformable material 121 may deform to squeeze chamber 117 to force the liquid fuel to exit. The liquid fuel component 122 contained therein is spilled out, passes through holes 126 and into fluid conduit 111, shown in FIGS. 4A and 4B. The fuel components react to produce fuel as discussed above.

Alternatively, chamber 106 may contain a capsule or package 151 as shown in FIG. 4D. Capsule 151 contains both liquid fuel component 122 and solid fuel component 107. Preferably, liquid fuel component 122 is contained within a fragile membrane pouch 153, made, for example, of a very thin sheet of plastic. Surrounding pouch 153 are outer walls 155 of capsule 151, which are preferably made from a gas permeable, liquid impermeable material such as CELGARD® or GORE-TEX®, although any such material as known in the art is appropriate. Disposed between outer walls 155 and pouch 153 is solid fuel component 107. When impacted by piercing mechanism 128, pouch 153 ruptures allowing solid fuel component 107 and liquid fuel component 122 to mix. The produced gas vents through walls 155 and into the fuel gas reservoir.

Alternatively, both outer walls 155 and pouch 153 could be fashioned from a similar fragile material so that both containers open when impacted. Solid fuel component 107 and liquid fuel component 122 can then mix in pod 127 or in the fuel gas reservoir. In such a case, pouch 153 need not be nested within outer walls 155, but two chambers 153a and 153b may simply reside adjacent to one another separated by a wall 156 made of the fragile material, as shown in FIG. 4E.

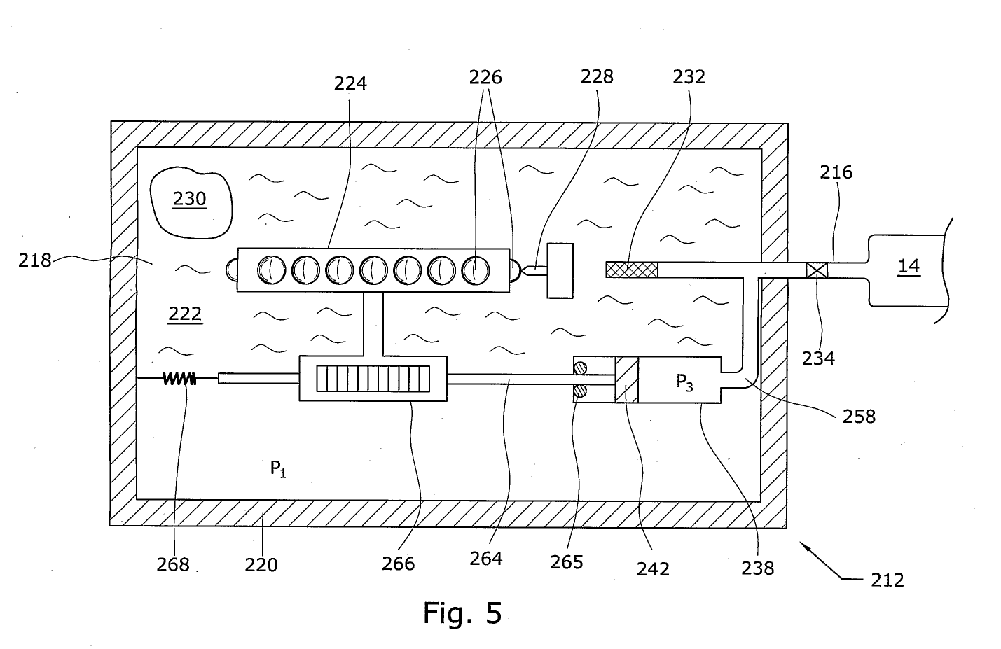

Referring to FIG. 5, another alternative gas-generating apparatus 212 is shown. Similar to the embodiments described above with respect to FIGS. 1-3, a reaction chamber 218 includes an indexing wheel 224 suspended within a fluid fuel component 222. Sealed pouches 226 containing a fuel component are disposed on the circumferential perimeter of indexing wheel 224. A releasing mechanism 228 is configured to open sealed pouches 226 as indexing wheel 224 turns.

The indexing mechanism in this exemplary embodiment includes a piston 242 sealingly disposed within a piston chamber 238 connected to a fuel conduit 216 via a pressure transfer tube 258. Thus, piston chamber 238 is exposed to the gas pressure in reaction chamber 218 via fuel conduit 216 and pressure transfer 258. A shaft 264 is fixedly attached at one end to piston 242 and extends out of an open end of piston chamber 238. Shaft 264 is configured with slots or similar structures along the length thereof. These slots engage with ratchet wheel 266.

Ratchet wheel 266 is attached to indexing wheel 224 so that ratchet wheel 266 is locked with indexing wheel 224 when turned in one direction, e.g., counterclockwise, but rotates freely with respect to indexing wheel 224 when turned in the opposite direction, e.g., clockwise. The other end of shaft 264 is connected to a biasing spring 268 which biases shaft 264 toward pressure transfer tube 258. Spring 268 may be any spring known in the art, such as a helical spring, with a sufficient spring constant to drive shaft 264. Preferably, the turning ratio of ratchet wheel 266 and indexing wheel 224 is the same; however, ratchet wheel 266 and indexing wheel 224 may also have different turning ratios.

Preferably, reaction chamber 218 is initially pressurized so that the pressure therewithin, P₁, is higher than a triggering pressure, P₂, to cause check valve 234 to open. As piston chamber 238 is fluidly connected to reaction chamber 218, a piston chamber pressure P₃ is equal to reaction chamber pressure P₁. Piston chamber pressure P₃ pushes on piston 240, and the force provided by piston chamber pressure P₃ and the force from biasing spring 268, K, balance at this point. When the forces on piston 242 balance, ratchet wheel 266 is prevented from turning.

As gas in reaction chamber 218 is transferred to a fuel cell 214 through a fuel conduit 216, reaction chamber pressure P₁ decreases. With the decrease in reaction chamber pressure P₁ comes a similar decrease in piston chamber pressure P₃. Once piston chamber pressure P₃ is reduced to the point that it no longer balances spring force K, spring 268 overcomes piston chamber pressure P₃ causing piston 242 and shaft 264 to slide axially within piston chamber 238 towards transfer tube 258, which causes ratchet wheel 266 to turn. As ratchet wheel 266 is locked with respect to indexing wheel 224 when turned in this direction, indexing wheel 224 also turns.

Similar to FIG. 2, as indexing wheel 224 turns, the sharp edge of releasing mechanism 228 opens at least one sealed pouch 226, thereby introducing the contained solid fuel component into fluid fuel component 222 to produce a gas within reaction chamber 218. In this exemplary embodiment, the turning motion of ratchet wheel 266 advances indexing wheel 224 a predetermined amount.

The produced gas in reaction chamber 218 increases reaction chamber pressure P₁. A portion of this produced gas is transferred through pressure transfer tube 258 into piston chamber 238. As such piston chamber pressure P₃ is also increased and presses on piston 240. Once piston chamber pressure P₃ exceeds spring force K, piston 242 and shaft 264 slide within piston chamber 260 towards biasing spring 268, which compresses. As stated above, ratchet wheel 266 moves freely when piston 242 and shaft 264 are moving towards biasing spring 268. Thus, although piston 242 and shaft 264 move ratchet wheel 266 and biasing spring 268, the movement of ratchet wheel 266 does not turn indexing wheel 224. When reaction chamber pressure P₁ exceeds threshold pressure P₂, the pressure to open check valve 234, gas begins to flow out of reaction chamber 218 and through optional shut-off valve 235 and into fuel cell 214.

Reaction chamber pressure P₁ and piston chamber pressure P₃ are again reduced due to the outflow of gas to fuel cell 214. When piston chamber pressure P₃ no longer exceeds spring force K, biasing spring 268 slides shaft 264 and piston 242 axially within piston chamber 238 toward transfer tube 258. This movement causes ratchet wheel 266 and indexing wheel 224 to move in concert as described above to introduce more solid fuel component into fluid fuel component 222. This cycle is summarized below in Table 3.

TABLE 3
Pressure Cycle for Ratchet Wheel Embodiment

| | Transfer of | | | |
|---|---|---|---|---|
| | Gas Between | | | |
| | Piston | | | Transfer of Gas |
| Pressure and | Chamber 238 | | | From Reaction |
| Force | and Reaction | Effect on | Effect on Fuel | Chamber 218 and |
| Relationships | Chamber 218 | Ratchet System | Cell Valve 234 | Fuel Cell 214 |
| P₁ = P₃ | No transfer | Piston 242 is | OPEN | Gas flows |
| P₃ = K | | balanced by | | |
| P₁ > P₂ | | spring 268 and | | |
| | | P₃, no movement | | |
| P₁ < P₃ | Gas flows out | Piston 242 slides | CLOSED | No flow |
| P₃ < K | of piston | to turn ratchet | | |
| P₁ < P₂ | chamber 238 | wheel 266 and | | |
| | | indexing wheel | | |
| | | 224 | | |
| P₁ = P₃ | No flow, gas | No movement | CLOSED | No flow, gas pressure |
| P₃ < K | builds pressure | | | builds within reaction |
| P₁ < P₂ | within reaction | | | chamber 18 |
| | chamber 218 | | | |
| P₁ = P₃ | Gas flows, | No movement | OPEN | Reaction is faster |
| P₃ < K | pressure builds | | | than release - |
| P₁ > P₂ | within reaction | | | building at a slower |
| | chamber 218 | | | rate |
| P₁ > P₃ | Gas flows into | Piston 242 moves | CLOSED | No flow |
| P₃ > K | piston chamber | to initial position | | |
| P₁ < P₂ | 238 | | | |

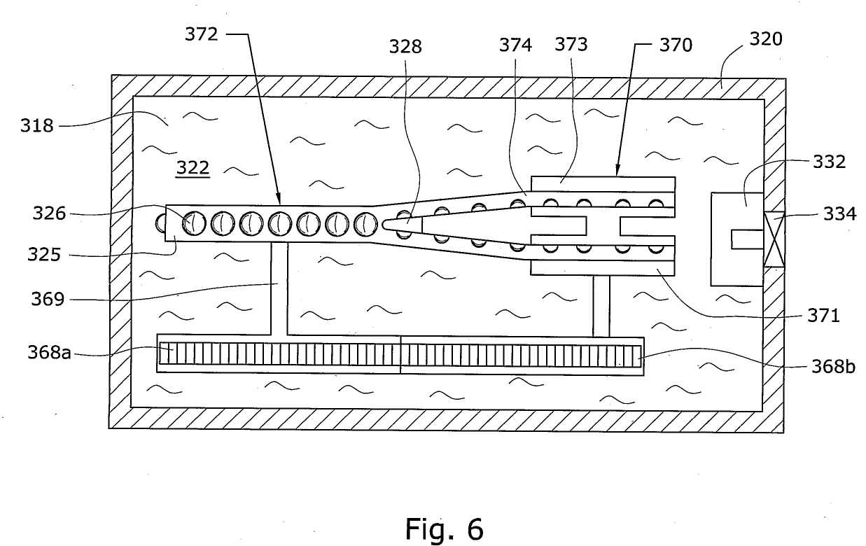

Referring to FIG. 6, yet another embodiment of a gas-generating apparatus 312 according to the present invention is shown. As in FIGS. 1-5, gas generating apparatus 312 generally includes a reaction chamber 318 defined by sidewalls 320. A fluid fuel component 322 is contained within reaction chamber 318. At least partially submerged within fluid fuel component 322 is a take-up wheel 370 and a feeding wheel 372, at least one of which is indexed. Disposed there between is a releasing mechanism 328, similar to those releasing mechanisms described above with respect to FIGS. 1-5. Preferably, releasing mechanism 328 is located and has a design such that it splits tape 325 into two sections that are then collected by take-up wheel 370. In one example, tape 325 is perforated, preferably at the center, so that releasing mechanism 328 may easily split tape 325 into two halves.

Feeding wheel 372 includes a tape 325 having a plurality of sealed pouches 326 formed thereon. Each sealed pouch 326 contains a predetermined amount of solid fuel. Preferably, feeding wheel 372 is mounted on an axle 369 in such a manner that feeding wheel 372 may spin easily. In other words, feeding wheel 372 may be free of any gears or other mechanism to advance or stop its movement. However, feeding wheel 372 and take-up wheel 370 may be mounted on gears 386a, 368b to assure that they move in concert with one another. When gears are used, preferably a clutch or slip mechanism is included to allow take up wheel 370 and feeding wheel 372 to slip relative to each other to prevent breakage of tape 325 due to the varying diameter of wheels 370, 372, as tape 325 is used. Similar to indexing wheel 24 as described above with respect to FIGS. 1 and 1A, feeding wheel 372 may be any appropriate wheel in the art made of a material capable of being submerged within fluid fuel component 322, such as a non-reactive metal or plastic.

Tape 325 extends from feeding wheel 372 to take-up wheel 370. Preferably, take-up wheel 370 is an indexing wheel similar to indexing wheel 24 as described above with respect to FIGS. 1 and 2, where take-up wheel is preferably ratcheted so that it may turn only in one direction. Take-up wheel 371 is preferably driven by an indexing mechanism similar to those described above, so that take up wheel 371 pulls tape 325 off of feeding wheel 372, over releasing mechanism 328 which splits tape 325 and pouches 326 open, and winds the spent pieces of tape 325 onto collection areas 371 and 373. When opened, pouches 326 empty their contents into fluid fuel component 322, thereby triggering the production of gas. Any known indexing methods may be used to drive take-up wheel 370. Preferably, any one of the spring-driven mechanisms described above for driving an indexing wheel may be used. The pressure cycles to automatically drive these indexing mechanisms are as described in the embodiments above.

In an alternative embodiment, both take-up wheel 370 and feeding wheel 372 are indexing wheels that use the same or different driving mechanism, such as one or more of the mechanisms described above. Furthermore, in another example, feeding wheel 372 is an indexing wheel that, when turned by one or more of the mechanisms described above, pushes a predetermined portion of tape 325 over the sharp edge of releasing mechanism 328 to split open sealed pouches 326. In this exemplary embodiment, take-up wheel 370 is preferably geared with feeding wheel 372 to wind the spent portions of tape 325.

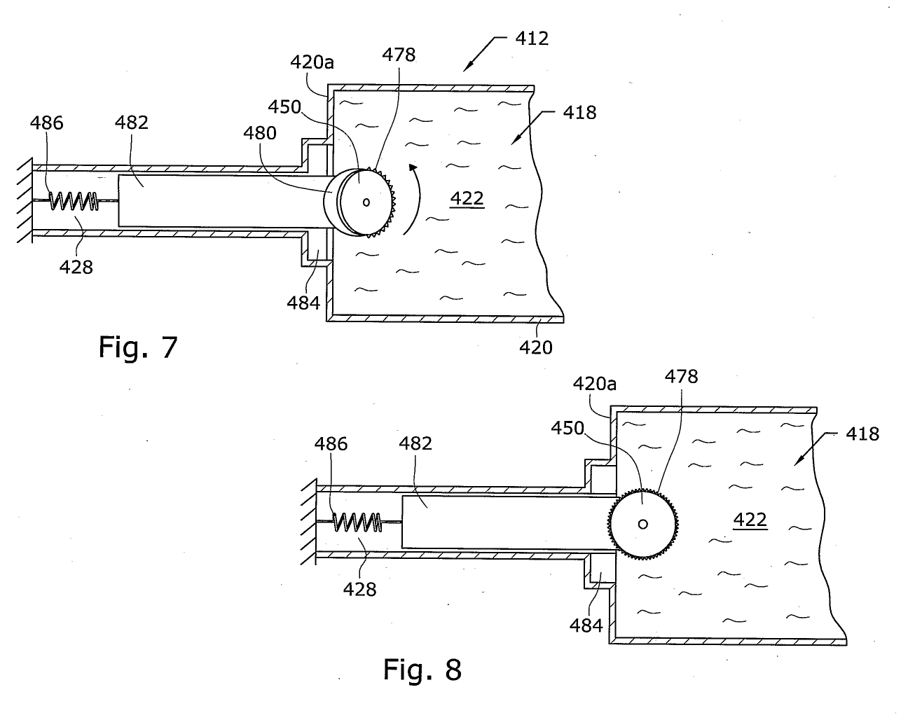

Referring to FIGS. 7 and 8, another embodiment of a gas-generating apparatus 412 according to the present invention includes a reaction chamber 418 enclosed in sidewalls 420, similar to those described above with respect to FIGS. 1-6. In one exemplary embodiment, reaction chamber 418 includes a fluid fuel component 422 and a grinding wheel 450. Preferably, fluid fuel component 422 is a liquid similar to the reactants described above with respect to FIGS. 1-5, and grinding wheel 450 is at least partially submerged in fluid fuel component 422.

Preferably, grinding wheel 450 is rotatably attached to sidewall 420a so that grinding wheel 450 may grind a portion of a fuel stick 482 to be introduced into fluid fuel component 422. Grinding wheel 450 may be of any diameter capable of releasing a portion of fuel stick into fluid fuel component 422. In this embodiment, grinding wheel 450 includes an outer surface, part of which includes a rough surface 478. Rough surface 478 may be roughened or knurled with grinding structures of any configuration known in the art, such as teeth, raised grains, or other protruding blades or scraping structures. Rough surface 478 may be formed from any material known to one skilled in the art appropriate for grinding, such as stainless steel. Preferably, the material of rough surface 478 is of a kind that is capable of grinding a solid fuel without sustaining significant damage, such as significant wearing or breaking to prevent grinding. The width of rough surface 478 may be selected to assure that an appropriate amount of fuel component is ground off of fuel stick 482 with each portion of a turn of grinding wheel 450.

At least one sidewall 420a opens to a fuel stick compartment 428 which houses a fuel stick 482. Fuel stick 482 is a solid fuel component, such as the fuel components described above in powdered form and sealed within pouches. In this embodiment, the fuel component is pressed, molded, or otherwise shaped into a solid form. While fuel stick 482 may be of any size or configuration, fuel stick 482 is preferably a stick having a square, rectangular, oval or round cross-sectional shape. The width of fuel stick 482 at its widest point is preferably smaller than the width of the grinding surface of grinding wheel 450.

Fuel stick compartment 428 preferably includes a biasing spring 486 which provides a force, on a fuel stick 482, which biasing force pushes fuel stick 482 toward the grinding wheel 450. The constant biasing force provided by 486 on fuel stick 482 ensures that fuel stick 482 remains in constant contact with grinding wheel 450. Additionally, to prevent fluid fuel component 422 from seeping into fuel stick compartment 428, fuel stick compartment 428 or reaction chamber 418 includes a seal 484. Preferably, seal 484 is made from a deformable sealing material that is inert to fuel stick 482 and fluid fuel component 422, such as natural or synthetic rubber and silicone.

The grinding wheel 450 of the present invention preferably includes an indexed driving mechanism, such as those described above with respect to the indexing wheels of FIGS. 1-4. When reaction chamber 418 is sufficiently pressurized due to the presence of a gas such as hydrogen, grinding wheel 450 is stationary. For example, if the driving mechanism shown in FIGS. 1 and 1A is used, grinding wheel 450 would not be turned. Alternatively, if the driving mechanism shown in FIG. 3 is used, grinding wheel 450 would be locked into position to prevent it from turning. As such, roughened surface 478 stops grinding against fuel stick 482. Optionally, a second portion of grinding wheel 450 includes a fuel seal 480. Fuel seal 480 is preferably fixedly attached to a portion of grinding wheel, such as with an adhesive, and preferably covers sufficient surface area of grinding wheel 450 such that fuel seal 480 prevents contact between fuel stick 482 and fluid fuel component 422 when fuel seal 480 is positioned against fuel stick 482. Fuel seal 480 may be made from any appropriate material, such as those described above with respect to seal 484. The purpose of fuel seal 480 is to preserve the characteristics of the portion of fuel stick 482 that is in contact with grinding wheel 450. Generally, the portion of fuel stick 482 that is in contact with grinding wheel 450 reacts with fluid fuel component 422 and forms a byproduct layer on the surface of the unused portion of fuel stick 482. While this byproduct layer prevents further reaction of fuel stick 482, effectively self-sealing fuel stick 482, the byproduct layer can cause the fuel component to react less efficiently when ground. As only a limited amount of fuel may be included with gas-generating mechanism 412, it is desirable to be able to utilize all of the fuel in fuel stick 482 as efficiently as possible. As such, fuel seal 480 inhibits the formation of the byproduct layer over the surface of fuel stick 482.

As the gas in reaction chamber 418 transfers to a fuel cell (not shown), the pressure inside reaction chamber 418 decreases. Once the pressure inside reaction chamber 418 reaches a predetermined value, grinding wheel 450 turns or is turned by the driving mechanism such that roughened surface 478 of grinding wheel 450 passes over fuel stick 482 to dislodge a portion of the fuel composition into fluid fuel component 422. The dislodged fuel reacts with fluid fuel component 422 to produce a fuel gas such as hydrogen. As the pressure again builds within reaction chamber 418, the driving mechanism stops the rotation of grinding wheel 450. Preferably, fuel seal 480 is in contact with fuel stick 482 when the rotation of grinding wheel 450 is stopped.

In an alternative example, as illustrated in FIG. 8, grinding wheel 450 does not include fuel seal 480. Instead, the surface of grinding wheel 450 is substantially covered by roughened surface 478. In all other respects, this embodiment operates in the same manner as the embodiment described with respect to FIG. 7.

Preferably, a motor is used for turning grinding wheel 450. This motor can be controlled electronically by a controller, such as, for example, a microprocessor, connected to a fuel cell (not shown) that controls a motor driving grinding wheel 450 (not shown). Similar to the motor-driven alternative described above with respect to FIGS. 1 and 1A, the controller in this alternative embodiment may monitor the pressure in reaction chamber 418 using one or more sensors, such as those described above. When the pressure within reaction chamber 418 drops below a predetermined value recorded on a table stored within the controller, then the controller signals the motor to turn grinding wheel 450. In another example, the controller may be able to monitor the flow rate of hydrogen gas from reaction chamber 418 into the fuel cell via a flow meter, which may be any flow meter known in the art. In this example, when the flow rate reduces below a predetermined value, the controller sends a signal to the motor on grinding wheel 450 to turn it an appropriate distance so that grinding wheel 450 grinds and dislodges a portion of fuel stick 482. The motor used may be any appropriate motor known in the art, preferably a battery operated MEMS motor.

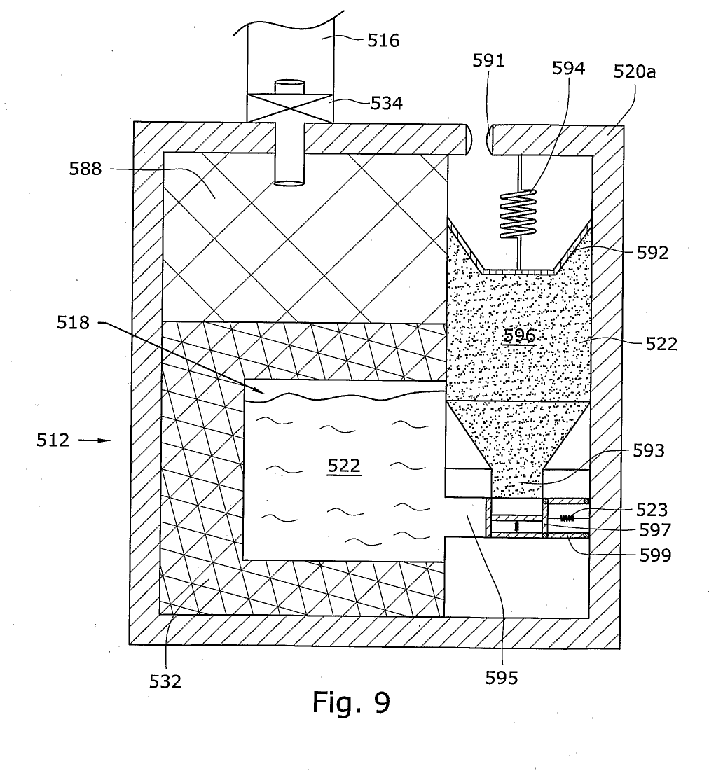

Referring to FIGS. 9-11, another alternative gas-generating apparatus 512 is shown. Gas-generating apparatus 512 includes a housing 520 configured to be attached to a fuel cell via a valve 534. Housing 520 is generally a box or cartridge-like walled structure similar to those described in the embodiments above. In one portion of housing 520, a gas permeable, liquid impermeable membrane 532 and the sidewalls of housing 520 define a reaction chamber 518 that is at least partially filled with a fluid fuel component 522. Gas permeable layer/membrane 532 may be any such membrane known in the art, such as those described above with respect to FIG. 1, and fluid fuel component 522 is a liquid appropriate for reacting with a fuel component such as the reactants described above. Optionally, a porous filler material 588 is disposed between valve 534 and liquid impermeable, gas permeable layer/membrane 532 to absorb any liquid that may pass through membrane 532

Also disposed within housing 520 is a fuel silo 522. Fuel silo 522 is a chamber containing a powdered or granular fuel component 596. Fuel silo 522 stores fuel component 596 until transferred to a slidable tray 599 with a compartment 597 formed therein located near an open lower end 593 of fuel silo 522.

To transfer a portion of fuel component 596 from fuel silo 522 to compartment 597, a piston 592 is positioned near the top of fuel silo 522 and is movably attached to housing 520 by a biasing spring 594. Biasing spring 594 provides a force which pushes piston 592 against an upper surface of fuel component 596 housed within fuel silo 522. Therefore, piston 592 is continuously attempting to push fuel component 596 into compartment 597. Preferably, a check valve 591 is located in a sidewall 520a to ensure that a vacuum is not created within fuel silo 522. Such a vacuum would likely inhibit the motion of piston 592.

In this embodiment, the indexing or the delivery of discrete quantities of a fuel component on demand is pressure-driven in the following manner. Generally, slidable tray 599 is housed within a guiding chamber 595 formed near open lower end 593 of fuel silo 522. Compartment 597 is disposed within slidable tray 599 and preferably includes an open top and a bottom formed by a plate 506 which is biased toward the open top of compartment 597 by a spring 508. The size of compartment 597 is selected so that a specific amount of solid fuel component 596 is introduced into reaction chamber 518 with each pass of slidable tray 599.

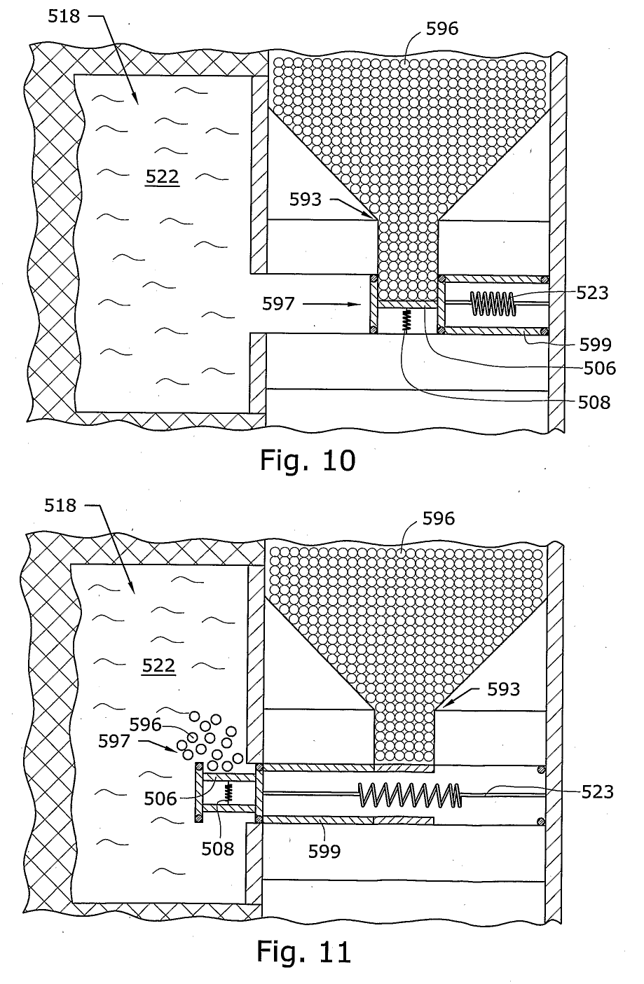

A biasing spring 523 is attached at one end to slidable tray 599 and at the other end to a sidewall 520b which forms one of the walls of guiding chamber 595. Biasing spring 523 provides a force, K, pushing slidable tray 599 toward reaction chamber 518. The pressure within reaction chamber 518, P₁, provides a variable force pushing slidable tray 599 toward sidewall 520b. As illustrated in FIG. 10, in a pressurized state, when reaction chamber pressure P₁ is sufficient to overcome spring force K, reaction chamber pressure P₁ moves slidable tray 599 within guiding chamber 595 so that compartment 597 aligns with open lower end 593 of fuel silo 522. A slug of fuel component 596 is thus able to be loaded into compartment 597 via piston 592 or gravity. As the slug of fuel component 596 is loaded into compartment 597, the weight of fuel component 596 pushes against plate 506, thereby compressing spring 508.

As the gas in reaction chamber 518 is transferred to a fuel cell through valve 534, reaction chamber pressure P₁ decreases. Once reaction chamber pressure P₁ no longer exceeds spring force K, as shown in FIG. 11, biasing spring 523 pushes slidable tray 599 toward reaction chamber 518 until compartment 597 is within reaction chamber 518. Spring 508 propels plate 506 toward the open top of compartment 597. Thus, fuel component 596 is delivered into fluid fuel component 522. Solid fuel component 596 reacts with fluid fuel component 522 to produce gas. As the gas is produced, reaction chamber pressure P₁ increases. When sufficient gas is produced, reaction chamber pressure P₁ exceeds spring force K, and slidable tray 599 is again pushed toward 520b until compartment 597 again aligns with open lower end 523 of fuel silo 522 as shown in FIG. 10. Compartment 597 is then refilled with solid fuel component 596 in anticipation of the next push forward into fuel compartment 518.

As slidable tray 599 is moved such that compartment 597 no longer aligns with open lower end 523 of fuel silo 522, as shown in FIG. 11, a rear portion of slidable tray covers or blocks open lower end 523 of fuel silo 522 to prevent fuel component 596 from emptying into guiding chamber 595.

Some examples of the solid fuel components that are used in the present invention include, but are not limited to, hydrides of elements of Groups IA-IVA of the Periodic Table of Elements and mixtures thereof, such as alkaline or alkali metal hydrides, or mixtures thereof. Other compounds, such as alkali metal-aluminum hydrides (alanates) and alkali metal borohydrides may also be employed. More specific examples of metal hydrides include, but are not limited to, lithium hydride, lithium aluminum hydride, lithium borohydride, sodium hydride, sodium borohydride, potassium hydride, potassium borohydride, magnesium hydride, calcium hydride, and salts and/or derivatives thereof. The preferred hydrides are sodium borohydride, magnesium borohydride, lithium borohydride, and potassium borohydride. Preferably, the hydrogen-bearing fuel comprises the solid form of NaBH₄, Mg(BH₄)₂, or methanol clathrate compound (MCC) is a solid which includes methanol. In solid form, NaBH₄ does not hydrolyze in the absence of water and therefore improves shelf life of the cartridge. However, the aqueous form of hydrogen-bearing fuel, such as aqueous NaBH₄, can also be utilized in the present invention. When an aqueous form of NaBH₄ is utilized, the chamber containing the aqueous NaBH₄ also includes a stabilizer. Exemplary stabilizers can include, but are not limited to, metals and metal hydroxides, such as alkali metal hydroxides. Examples of such stabilizers are described in U.S. Pat. No. 6,683,025, which is incorporated herein by reference in its entirety. Preferably, the stabilizer is NaOH.

The solid form of the hydrogen-bearing fuel is preferred over the liquid form. In general, solid fuels are more advantageous than liquid fuels because the liquid fuels contain proportionally less energy than the solid fuels and the liquid fuels are less stable than the counterpart solid fuels. Accordingly, the most preferred fuel for the present invention is powdered or agglomerated powder sodium borohydride.

According to the present invention, the liquid reactant preferably comprises an agent that is capable of reacting with a hydrogen-bearing fuel in the presence of an optional catalyst to generate hydrogen. Preferably, the agent is, but not limited to, water, alcohols, and/or dilute acids. The most common source of agent is water. As indicated above and in the formulation below, water may react with a hydrogen-bearing fuel, such as NaBH₄ in the presence of an optional catalyst to generate hydrogen.

X(BH₄)_{y}+2H₂O→X(BO)₂+4H₂

Where X includes, but is not limited to, Na, Mg, Li and all alkaline metals, and y is an integer.

The reactant also includes optional additives that reduce or increase the pH of the solution. The pH of the reactant can be used to determine the speed at which hydrogen is produced. For example, additives that reduce the pH of the reactant result in a higher rate of hydrogen generation. Such additives include, but are not limited to, acids, such as acetic acid and sulfuric acid. Conversely, additives that raise the pH can lower the reaction rate to the point where almost no hydrogen evolves. The solution of the present invention can have any pH value less than 7, such as a pH of from about 1 to about 6 and, preferably, from about 3 to about 5. Additional discussion of appropriate pH may be found in co-owned, co-pending '572 application previously incorporated by reference.

In some exemplary embodiments, the reactant optionally includes a catalyst that can initiate and/or facilitate the production of hydrogen gas by increasing the rate at which the reactant reacts with the fuel component. This optional catalyst of these exemplary embodiments includes any shape or size that is capable of promoting the desired reaction. For example, the catalyst can be small enough to form a powder or it can be as large as the reaction chamber. In some exemplary embodiments, the catalyst is a catalyst bed. The catalyst can be located inside the reaction chamber or proximate to the reaction chamber, as long as at least one of either the reactant or the fuel component comes into contact with the catalyst.

The catalyst of the present invention may include one or more transitional metals from Group VIIIB of the Periodic Table of Elements. For example, the catalyst may include transitional metals such as iron (Fe), cobalt (Co), nickel (Ni), ruthenium (Ru), rhodium (Rh), platinum (Pt), palladium (Pd), osmium (Os) and iridium (Ir). Additionally, transitional metals in Group IB, i.e., copper (Cu), silver (Ag) and gold (Au), and in Group IIB, i.e., zinc (Zn), cadmium (Cd) and mercury (Hg), may also be used in the catalyst of the present invention. The catalyst may also include other transitional metals including, but not limited to, scandium (Sc), titanium (Ti), vanadium (V), chromium (Cr) and manganese (Mn). Transition metal catalysts useful in the present invention are described in U.S. Pat. No. 5,804,329, which is incorporated herein by reference in its entirety. The preferred catalyst of the present invention is CoCl₂.

Some of the catalysts of the present invention can generically be defined by the following formula:

MₐX_{b}

wherein M is the cation of the transition metal, X is the anion, and “a” and “b” are integers from 1 to 6 as needed to balance the charges of the transition metal complex.

Suitable cations of the transitional metals include, but are not limited to, iron (II) (Fe²⁺), iron (III) (Fe³⁺), cobalt (Co²⁺), nickel (II) (Ni²⁺), nickel (III) (Ni³⁺), ruthenium (III) (Ru³⁺), ruthenium (IV) (Ru⁴⁺), ruthenium (V) (Ru⁵⁺), ruthenium (VI) (Ru⁶⁺), ruthenium (VIII) (Ru⁸⁺), rhodium (III) (Rh³⁺), rhodium (IV) (Rh⁴⁺), rhodium (VI) (Rh⁶⁺), palladium (Pd²⁺), osmium (III) (Os³⁺), osmium (IV) (Os⁴⁺), osmium (V) (Os⁵⁺), osmium (VI) (Os⁶⁺), osmium (VIII) (Os⁸⁺), iridium (III) (Ir³⁺), iridium (IV) (Ir⁴⁺), iridium (VI) (Ir⁶⁺), platinum (II) (Pt²⁺), platinum (III) (Pt³⁺), platinum (IV) (Pt⁴⁺), platinum (VI) (Pt⁶⁺), copper (I) (Cu⁺), copper (II) (Cu²⁺), silver (I) (Ag⁺), silver (II) (Ag²⁺), gold (I) (Au⁺), gold (III) (Au³⁺), zinc (Zn²⁺), cadmium (Cd²⁺), mercury (I) (Hg⁺), mercury (II) (Hg²⁺), and the like.

Suitable anions include, but are not limited to, hydride (H⁻), fluoride (F⁻), chloride (Cl⁻), bromide (Br⁻), iodide (I⁻), oxide (O²⁻), sulfide (S²⁻), nitride (N³⁻), phosphide (P⁴⁻), hypochlorite (ClO⁻), chlorite (ClO₂⁻), chlorate (ClO₃⁻), perchlorate (ClO₄⁻), sulfite (SO₃²⁻), sulfate (SO₄²⁻), hydrogen sulfate (HSO₄⁻), hydroxide (OH⁻), cyanide (CN⁻), thiocyanate (SCN⁻), cyanate (OCN⁻), peroxide (O₂²⁻), manganate (MnO₄²⁻), permanganate (MnO₄⁻), dichromate (Cr₂O₇²⁻), carbonate (CO₃²⁻), hydrogen carbonate (HCO₃⁻), phosphate (PO₄²⁻), hydrogen phosphate (HPO₄⁻), dihydrogen phosphate (H₂PO₄⁻), aluminate (Al₂O₄²⁻), arsenate (AsO₄³⁻), nitrate (NO₃⁻), acetate (CH₃COO⁻), oxalate (C₂O₄²⁻), and the like. A preferred catalyst is cobalt chloride.

In some exemplary embodiments, an optional additive may be included in the reactant and/or in the reaction chamber. This optional additive is any composition that is capable of substantially preventing the freezing of or reducing the freezing point of the reactant and/or the fuel component. In some exemplary embodiments, the additive can be an alcohol-based composition, such as an anti-freezing agent. Preferably, the additive of the present invention is CH₃OH. However, as stated above, any additive capable of reducing the freezing point of the reactant and/or the fuel component may be used.

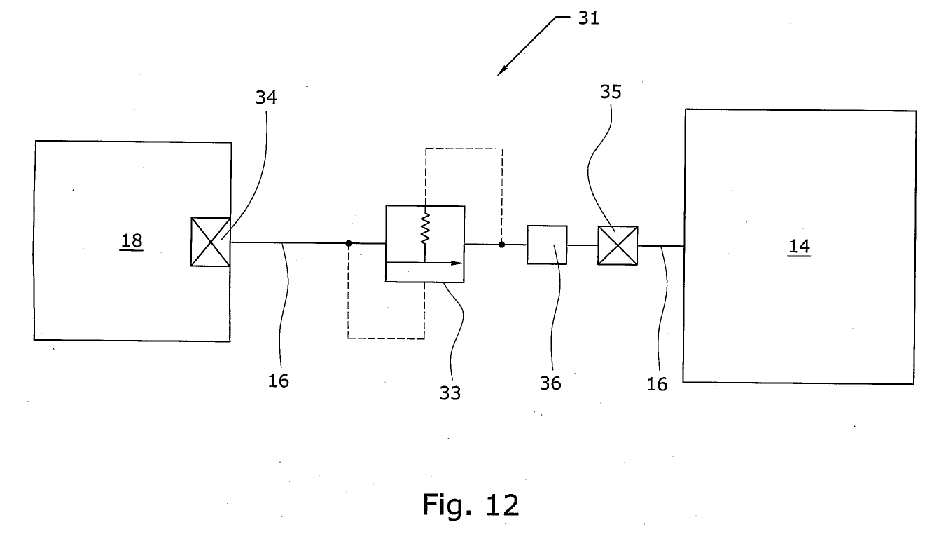

Additionally, in order to control the flow characteristics, such as pressure and flow rate, of the fuel gas produced by any of the gas-generating apparatus discussed above with respect to FIGS. 1-11, a flow control system 31 as shown in FIG. 12 may be used to connect a fuel reservoir 18 to a fuel cell system 14. Flow control system 31 preferably includes a valve 34 to control the output of gas-generating apparatus 18, as described above with respect to, inter alia, FIGS. 1 and 1A. Shut-off valve 35 may also be provided. Fuel gas flows through valve 34 and into a fuel transfer conduit 16. Along the length of fuel transfer conduit 16 is a pressure regulator 33, which may be any type of pressure regulator known in the art. Preferably, given the potential variations in output pressure, pressure regulator 33 is a two-stage pressure regulator, where the first stage reduces the pressure a set amount, then the second stage optimizes the pressure. An appropriate pressure regulator is the PRD2 pressure regulator available from Beswick Engineering of Greenland, N.H. Additionally, in order to further control flow rate, an optional orifice 36 having a small diameter is positioned downstream of pressure regulator 33. A preferred diameter for orifice 36 is about 0.05 mm, although the size of orifice 36 depends on many factors including the type of fuel, the type of fuel cell, and the load driven by the fuel cell. The combination of pressure regulator and orifice 36 allows for a near constant flow rate of fuel into fuel cell 14.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. We claim:
a gas-generating apparatus comprising:
a reaction chamber;
a first reactant disposed within the reaction chamber; and
an indexing mechanism operatively connected to a second reactant and configured to introduce a second reactant into the reaction chamber so that a gas is produced by a reaction between the first reactant and the second reactant.

2. The gas-generating apparatus of claim 1, wherein the second reactant is located on the indexing mechanism.

3. The gas-generating apparatus of claim 1, wherein the indexing mechanism is pressure-driven.

4. The gas-generating apparatus of claim 1, wherein the indexing mechanism comprises a ratcheted wheel.

5. The gas-generating apparatus of claim 4 further comprising:
a plurality of sealed pouches disposed on an exterior surface of the ratcheted wheel, wherein the second reactant is contained within the sealed pouches; and
a releasing mechanism, wherein the releasing mechanism is configured to open at least one of the sealed pouches as the ratcheted wheels turned.

6. The gas-generating apparatus of claim 5, wherein the ratcheted wheel is turned by a pressure-driven pawl mechanism, wherein the pawl engages with at least one of a plurality of downwardly angled teeth attached to the ratcheted wheel.

7. The gas-generating apparatus of claim 6, wherein the pawl is a spring arm.

8. The gas-generating apparatus of claim 6, wherein the pawl is hingedly attached to the ratcheted wheel.

9. The gas-generating apparatus of claim 6, wherein the pawl is connected to a pressure-driven piston.

10. The gas-generating apparatus of claim 6 wherein the ratcheted wheel is turned by a wound torsion spring.

11. The gas-generating apparatus of claim 7 further comprising a drive mechanism comprising a spring-loaded pressure-driven geared rod engaged with a correlating gear connected to the ratcheted wheel.

12. The gas-generating apparatus of claim 1, further comprising a feeding wheel comprising a tape having a plurality of sealed pouches containing the second reactant disposed on an exterior surface of the feeding wheel, wherein the indexing mechanism is a take-up wheel, and wherein the tape extends to the take-up wheel, and wherein so the take-up wheel is configured to pull the tape over a releasing mechanism.

13. The gas-generating apparatus of claim 1, wherein the indexing mechanism is driven by a motor.

14. The gas-generating apparatus of claim 1 further comprising a grinding wheel disposed within the reaction chamber, wherein the second fuel reactant is a solid fuel component formed into a grindable mass, and wherein the second fuel reactant is ground to introduce the second reactant into the reaction chamber.

15. The gas-generating apparatus of claim 14 further comprising a driving mechanism for turning the grinding wheel, wherein the driving mechanism is controlled by the pressure within the reaction chamber.

16. The gas-generating apparatus of claim 15, wherein the grinding wheel is turned by a motor.

17. The gas-generating apparatus of claim 15, wherein the surface of the grinding wheel is at least partially covered with a sealing material.

18. The gas-generating apparatus of claim 1 further comprising
a fuel silo adjacent to the reaction chamber, wherein the fuel silo contains the second reactant, and
a fuel transfer system for moving the second reactant from the fuel silo to the reaction chamber, wherein at least one wall of the reaction chamber comprises a liquid impermeable, gas permeable membrane.

19. The gas-generating apparatus of claim 18, wherein the fuel transfer system comprises is controlled by a pressure within the reaction chamber.

20. The gas-producing apparatus of claim 1 further comprising a plurality of pods.

21. The gas-generating apparatus of claim 20, wherein the reaction chamber is located in each of the plurality of pods, and
wherein an activation member is positioned within the reaction chamber and adjacent to the first reactant, and
wherein the reservoir is formed within each of the plurality of pods adjacent to the reaction chamber, wherein the reservoir contains the second reactant, and
wherein a frangible membrane separates the reaction chamber from the reservoir, wherein the indexing mechanism is configured to select one of the plurality of pods and advance the activation member toward the reservoir to introduce the second reactant into the reaction chamber of the selected pod.

22. The gas-generating apparatus of claim 20, wherein each pod comprises a micromachined chamber containing the second reactant, and wherein each micromachined chamber is operatively connected to a controller, and wherein the plurality of pods is separated from the reaction chamber by a screen so that at least one micromachined chamber is actuated to transfer its contents into the reaction chamber when activated by the controller.

23. The gas-generating apparatus of claim 22 further comprising a plurality of piezoelectric elements, wherein at least one of the plurality of piezoelectric elements is operatively connected to an associated micromachined chamber, wherein an electrical signal from the controller to the piezoelectric element actuates its associated micromachined chamber.

24. The gas-generating apparatus of claim 20, wherein the reaction chamber is located in each of the plurality of pods, wherein the second reactant is separated from the first reactant by a fragile membrane, and wherein the indexing mechanism is configured to release the second reactant of each of the plurality of pods sequentially.

25. The gas-generating apparatus of claim 1, wherein the first reactant is a liquid.

26. The gas-generating apparatus of claim 1, wherein the second reactant is a solid.

27. The gas-generating apparatus of claim 1 further comprising a fuel cell connected to the reaction chamber, wherein a cathode side of the fuel cell is exposed to an oxidant and an anode side of the fuel cell is exposed to an interior of the reaction chamber.

28. The gas-generating apparatus of claim 27, wherein a cover is selectively positioned on the cathode side when the gas is transferred out of the gas-generating apparatus.

29. A gas generating apparatus comprising means for introducing a solid fuel component into a liquid reactant.
